(19) United States
(12) Patent Application Publication
(10) Pub. No.: US 2009/0099044 A1
(43) Pub. Date: Apr. 16, 2009

(54) Nanoparticles and Method to Control Nanoparticle Spacing

(76) Inventors: James E. Hutchison, Eugene, OR (US); Gerd H. Woehrle, Eugene, OR (US); Marvin G. Warner, Eugene, OR (US); Leif O. Brown, Santa Fe, NM (US)

Correspondence Address: KLARQUIST SPARKMAN, LLP, 121 SW SALMON STREET, SUITE 1600, PORTLAND, OR, 97204, US

(21) Appl. No.: 11/920,375

(22) PCT Filed: May 22, 2006
(86) PCT No.: PCT/US06/19861

§ 371 Date: Nov. 13, 2007

Related U.S. Application Data
(60) Provisional application No. 60/683,140, filed on May 20, 2005.

(51) Int. Cl. C40B 50/14; C07F 7/08

(52) U.S. Cl. 506/30; 556/110; 977/773

(57) ABSTRACT

Disclosed herein are novel nanoparticles, particularly metal nanoparticles, such as gold nanoparticles. According to one embodiment of a method disclosed herein nanoparticles are functionalized via ligand exchange reactions. Also disclosed is a method for controlling nanoparticle spacing to produce nanoparticle arrays having defined spacing. Such nanoparticles and arrays thereof are particularly useful in nanoelectronics, nanophotonics, catalysis, sensors, and biotaggents.

### CROSS REFERENCE TO RELATED APPLICATION

This application claims the benefit of the earlier filing date of U.S. provisional patent application No. 60/683,140 filed May 20, 2005, which is incorporated herein by reference.

### ACKNOWLEDGEMENT OF GOVERNMENT SUPPORT

This invention was made with government support under Grant No. DMR-9705343 awarded by the National Science Foundation. The government has certain rights in the invention.

### FIELD

Disclosed herein are nanoparticles and nanoparticle arrays as well as methods for making nanoparticles and nanoparticle arrays having defined interparticle spacing.

### BACKGROUND

The ability to pattern high-density, nanometer-scale structures through convenient, highly-parallel processes is an important challenge in nanoscience and nanotechnology. For electronic and optical applications of nanostructures (e.g. room temperature nanoelectronics, nanophotonics, and spintronics), the ability to control precisely the feature sizes and the spacing between the individual features with nanometer- or Ångström-level precision is necessary in order to manipulate the electronic and optical interactions (e.g. tunneling barriers, capacitive coupling, wave function overlap, energy transfer) between neighboring structures and thus tune device function and properties. Construction of nanoscale structures and devices with the required dimensions for these applications has been approached through lithographic approaches (providing dimensions in the range of 10-50 nm). A number of lithographic nanoscale-patterning techniques are currently being developed for fabricating structures with minimum feature sizes below 50 nm. These include electron and particle beam, nanoimprint, and scanning probe methods. Thus far, state-of-the-art lithographic methods have been limited to patterning materials with critical feature dimensions of about ten nanometers and the amount of control and resolution needed for certain electronic and optical applications has not yet been met. See, Xia, Y.; Rogers, J. A.; Paul, K. E.; Whitesides, G. M. Chem. Rev. 1999, 99, 1823-1848 and Wallraff, G. M.; Hinsberg, W. D. Chem. Rev. 1999, 99, 1801-1821.

In patterning approaches based upon template- or scaffold-assisted self-assembly, nanometer-sized structures (building blocks) define the feature sizes, often well below the limits of state-of-the-art lithographic methods. However, precise control of the feature separation has not yet been achieved by the patterning approaches employed to date.

### SUMMARY

Disclosed herein is a method for preparing nanoparticle arrays having defined interparticle spacing. In one embodiment the method includes functionalizing phosphine-stabilized nanoparticles with a desired ligand via a ligand exchange reaction. In one aspect of the method, a particular ligand is selected to provide a desired ligand shell thickness. For example, the ligand can be used to define the nanoparticle separation. In one embodiment of the method, the array is formed by depositing the nanoparticles on a substrate before or after the ligand exchange reaction, however typically a ligand that defines the desired interparticle separation is attached to the nanoparticles before deposition of the nanoparticles.

In one embodiment, the array is further defined by chemical features deposited or patterned on a substrate. For example the chemical features typically include functional groups that interact covalently or noncovalently with the nanoparticles to couple the nanoparticles to the substrate in a defined location. In one embodiment the chemical features are provided by a deposited molecule, such as a macromolecule, particularly a peptide or nucleic acid having a desired secondary and/or tertiary structure.

In one embodiment the method for producing defined arrays provides the ability to reliably and reproducibly generate nanoscale device architectures in a highly parallel fashion and interface these structures to the macroscale world.

Also disclosed herein is a method for making nanoparticles having particular ligands coordinated to the nanoparticle. For example, one embodiment of the method employs a ligand exchange reaction to prepare gold nanoparticles, particularly highly functionalized thiol-stabilized gold nanoparticles, from a readily accessible phosphine-stabilized precursor nanoparticle. The surprisingly high tolerance for a large variety of technologically important functional groups makes this approach of great interest for many different nanoparticle applications. This approach is particularly useful for providing convenient access to previously inaccessible nanoparticles in the size regime (d_{core}) from about 1 to about 5 nm, such as from about 0.8 to about 2 nm.

In one embodiment the method can be used to control the composition of the ligand shell. For example, ligand exchange can be partly blocked in a controlled manner, which enables the production of novel nanoparticles with mixed phosphine/thiol ligand shells.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates the solution-phase formation of linear, close packed DNA-nanoparticle assemblies.

FIG. 2 is transmission electron microscope (TEM) images of linear, close-packed nanoparticle-DNA assemblies with precisely controlled interparticle spacing.

FIG. 3 is a TEM micrograph of a ˜31 nm long nanoparticle chain of Auₙ-TMAT on λ-DNA illustrating that the ligand shell of the nanoparticle enforces a defined interparticle spacing even in non-linear assemblies.

FIG. 4 is a TEM analysis of the interparticle spacing within a single extended Auₙ-MEMA nanoparticle chain, wherein the representative nanoparticle-DNA structure shown demonstrates the robust control of spacing within an extended chain and illustrates the high degree of linearity within these assemblies.

FIG. 5 illustrates representative ligand exchange reactions.

FIG. 6A charts the time course of the ligand exchange between 1.5 nm Auₙ-TPP (c=66.7 μmol/L) and octadecanethiol (ODT) (c=16.7 mmol/L) monitored by ¹H NMR spectroscopy of the α-methylene resonance of ODT.

FIG. 6B charts the time course of the ligand exchange between 1.5 nm Auₙ-TPP (c=66.7 μmol/L) and ODT (c=16.7 mmol/L) monitored by ¹H NMR spectroscopy of the β-methylene resonance of ODT.

FIG. 7 charts the concentrations of bound ODT and phosphine-containing species in solution as a function of time during ligand exchange.

FIG. 8 charts the percentage of ODT in solution to the total amount of ODT added to the ligand exchange reaction as a function of time using the following concentrations: [1.5-nm Auₙ-TPP]=66.7 μmol/L; [ODT]=16.7 mmol/L; [PPh₃]=66.7 mmol/L.

FIG. 9 illustrates a three-stage mechanism for the ligand exchange reaction between 1.5-nm Auₙ-TPP and thiols.

### DETAILED DESCRIPTION

Disclosed herein is a method that offers a rapid, reliable and convenient approach to fabricate nanometer-sized structures in a highly parallel fashion. One embodiment of the method involves biomolecular nanolithography wherein a nanoparticle ligand shell is used to control the spacing between neighboring nanoparticles with Ångström-level resolution. This approach can be used to enforce nanoparticle spacing in linear and non-linear arrangements. In one embodiment, the method overcomes structural defects of the template, by maintaining the interparticle spacing. The disclosed method achieves Ångström-level precision over the range of interparticle spacing between about 1 to about 3 nanometers, such as between 1.5 and 3 nanometers. Accordingly, the method is useful for tuning electronic and optical properties, such as tunneling barriers and wave function overlap, for application to, for example, nanoelectronics and nanophotonics.

The biomolecular lithographic approach disclosed herein yields greater control over the patterning of features on the nanometer scale. First, the interparticle spacing is highly reproducible and only shows a low deviation which allows precise control of interparticle interactions. Second, the assembly process tolerates structural defects in the DNA template and enforces the interparticle spacing in non-linear sections of the template. Finally, the total coverage of isolated, single DNA strands is higher than 90%, which demonstrates the high yield of the assembly process. This approach is an alternative to current lithographic methods, overcoming several limitations inherent to those methods. The disclosed method can be applied to diverse core/shell materials including both metals and semiconductors to form well-ordered structures on DNA scaffolds. More elaborate structures also can be prepared with the same degree of control by utilizing the structural versatility of more sophisticated DNA templates.

The lithographic approaches disclosed herein optionally can be combined with the methods disclosed in U.S. provisional application No. 60/680,919, entitled METHOD FOR FUNCTIONALIZING SURFACES, and filed May 13, 2005, in the names of James E. Hutchison, Christina E. Inman, Gregory J. Kearns, Shuji Goto and Evan Foster, which is incorporated herein by reference in its entirety. Also incorporated herein by reference is U.S. provisional application No. 60/683,109, entitled NEW COMPOSITIONS OF AU-11 NANOPARTICLES AND THEIR OPTICAL PROPERTIES, and filed May 20, 2005, in the names of James E. Hutchison and Gerd H. Woehrle.

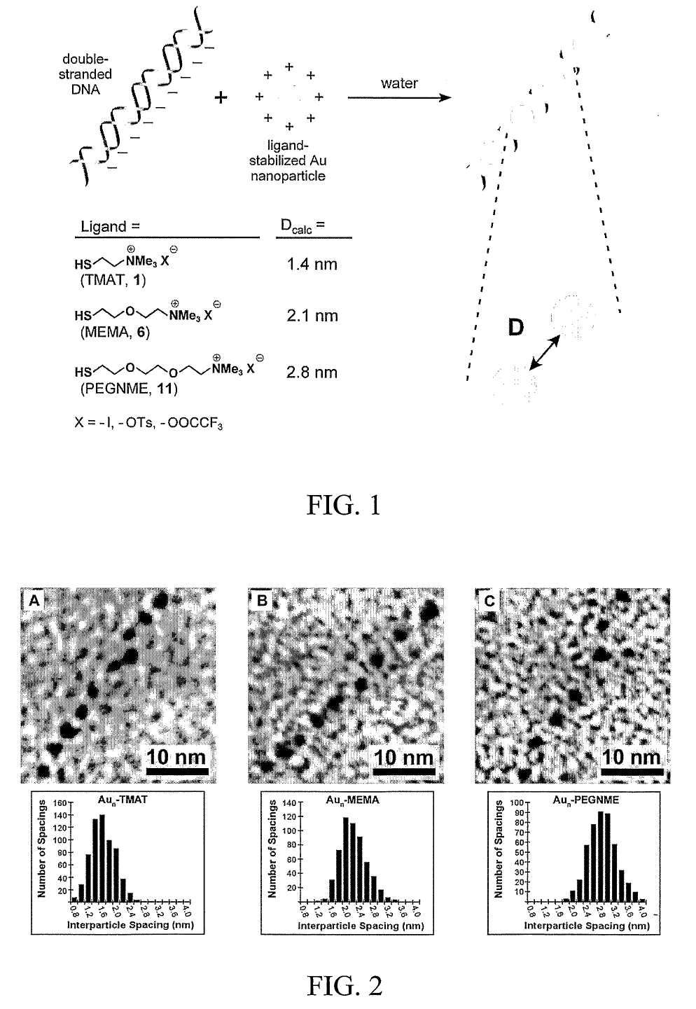

With reference to FIG. 1, double-stranded DNA provides an architectural scaffold for the assembly of ligand-stabilized gold nanoparticles. The positive charges of the ammonium head groups at the periphery of the nanoparticle ligand shell direct organization along the phosphate-backbone of the DNA template to form a close-packed assembly. The interparticle spacing D between neighboring nanoparticles is set by the thickness of the ligand shell l on each particle and is twice that thickness (D=2 l). By varying the thickness of the ligand shell, the spacing can be controlled. Three exemplary ligands used were (2-mercaptoethyl)-trimethylammonium iodide (TMAT), [2-(2-mercaptoethoxy)-ethyl]-trimethylammonium toluene-4-sulfonate (MEMA), and {2-[2-(2-mercaptoethoxy)-ethoxy]-ethyl}-trimethylammonium toluene-4-sulfonate (PEGNME). Molecular mechanics calculations predict that the interparticle spacing (D) within the close-packed assemblies of these nanoparticles can be tuned from 1.4 nm to 2.8 nm using TMAT, MEMA, and PEGNME, respectively.

Shown in FIG. 2 are representative high-resolution TEM images of linear nanoparticle chains of Auₙ-TMAT, Auₙ-MEMA, and Auₙ-PEGNME, respectively, assembled on λ-DNA. The chains in each panel span distances of approximately 40 nm. The spacing between neighboring nanoparticles systematically increases with increasing ligand shell thickness from greater than about 1 nm to less than about 3 nm with specific embodiments having a shell thickness of about 1.5 nm in FIG. 2A (Auₙ-TMAT) to 2.8 nm in FIG. 2C (Auₙ-PEGNME). The calculated interparticle spacing D (D=2 l assuming that the thickness of the ligand shell l equals the length of the stabilizing ligand in its fully extended conformation) and is 1.4 nm for TMAT-functionalized nanoparticles, 2.1 nm for nanoparticles stabilized by MEMA, and 2.8 nm for PEGNME-functionalized nanoparticles (FIG. 1). Analysis of large numbers (ca. 500) of interparticle spacings for all three systems confirms that the predicted spacing can be implemented with exceptional precision. Interparticle spacings of 1.5±0.3 nm were found for Auₙ-TMAT, 2.1±0.4 nm for Auₙ-MEMA, and 2.8±0.4 nm for Auₙ-PEGNME. These values agree with the values predicted as above. The small standard deviations (≦20%) further indicate the reproducibility and reliability of this method to generate evenly-spaced nanoparticle chains with a high degree of control. These data clearly demonstrate the ability to precisely control the interparticle spacing with a resolution of only a few Ångströms in a size regime of ˜1-3 nm. Control in this size regime is essential for electronic and optical applications since it offers the possibility to tune both classical and quantum interactions between neighboring structures (Collier, C. P.; Saykally, R. J.; Shiang, J. J.; Henrichs, S. E.; Heath, J. R. Science 1997, 277, 1978-1981).

The representative TEM micrographs of FIG. 2 demonstrate the use of three different ligands to produce linear arrays with different spacing between neighboring nanoparticles. The images were taken at 200K magnification and are shown on the same scale for comparison. The histograms were obtained by measuring the interparticle spacings of a large number of representative structures. (A) A chain of Auₙ-TMAT nanoparticles stretching ˜39 nm. The histogram shows an average interparticle spacing of 1.5±0.3 nm (N=630). (B) A chain of Auₙ-MEMA nanoparticles spanning ˜41 nm. The histogram shows an average interparticle spacing is 2.1±0.4 nm (N=549). (C) A chain of Auₙ-PEGNME nanoparticles spanning ˜38 nm. The histogram shows an average interparticle spacing of 2.8±0.4 nm (N=473). These data demonstrate that the interparticle spacing increases systematically with increasing length of the stabilizing ligands on the nanoparticles. In all cases, the average interparticle spacing equals twice the ligand shell thickness predicted from modeling.

There is uncertainty introduced into the measurement due to the precision of the TEM measurement and the digitization of the data by the computer-assisted analysis. Furthermore, one has to consider the variation introduced by projecting 3-D structures onto a 2-D plane during imaging. Variations in height are lost during this process, which can result in measuring smaller interparticle distances than actually occur. Each of these factors leads to an artificial increase in the variation of the interparticle spacing, thus the standard deviations given herein should be regarded as an upper limit. Therefore the actual interparticle spacing precision likely is better than indicated by the given standard deviations.

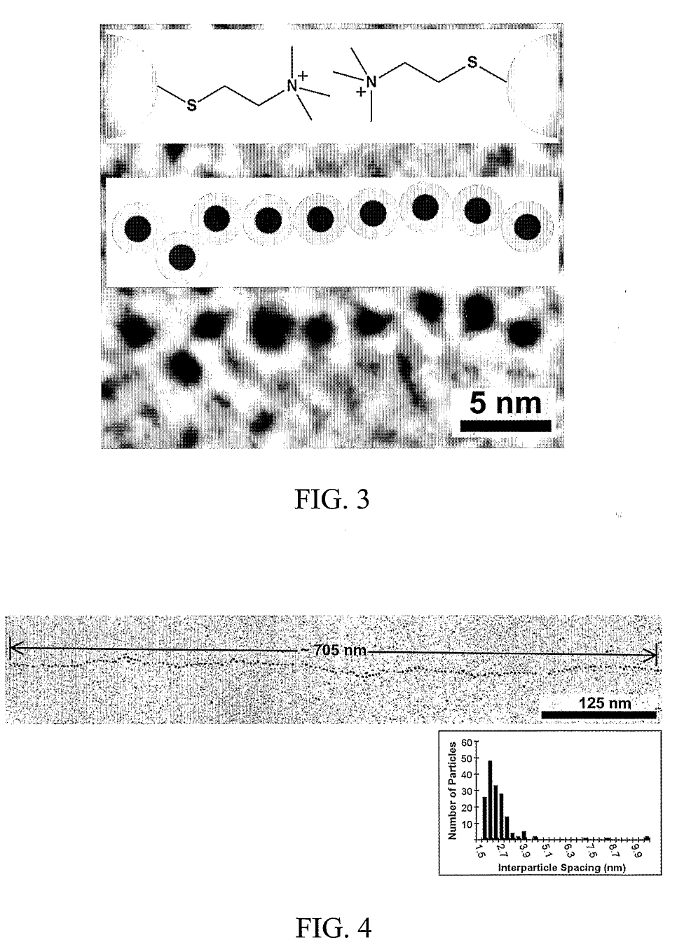

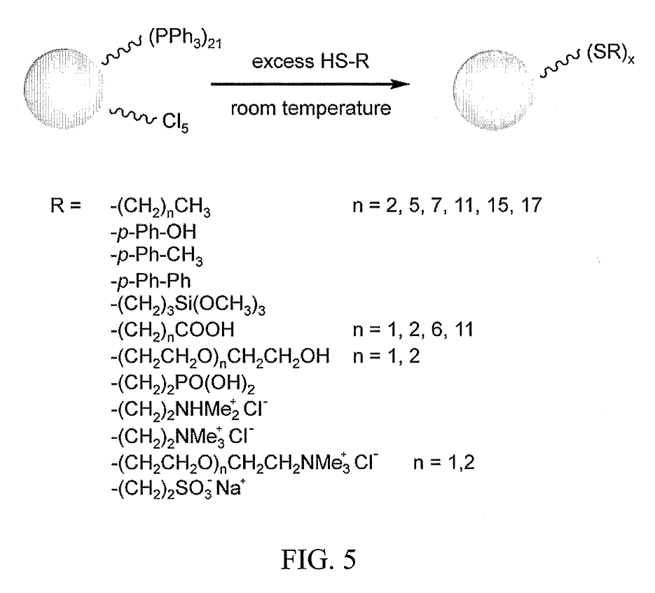

With reference to FIG. 3, the top inset shows close packing of nanoparticles along the DNA scaffold and the influence of the ligand shells of neighboring nanoparticles on the interparticle spacing. The lower inset shows a model of the nanoparticle chain in the micrograph using idealized nanoparticles (total diameter 3.7 nm for the core plus the shell) for comparison to the observed chain. The particles in the model are arranged such that they trace the original nanoparticle chain. All particles can be lined up between the model and the original demonstrating that the interparticle spacing is dictated by the ligand shell even in slightly distorted sections of the assembly (illustrated by the three particles on the left-hand end of the chain).

In certain embodiments, the nanoparticle ligand shell is used to enforce interparticle spacing in nonlinear arrays. For example, the Auₙ-TMAT nanoparticles in the assembly shown in FIG. 3 are arranged such that they form an almost completely linear structure with the exception of the particle on the left which is clearly offset from the line. To elucidate if the interparticle spacing in the distorted region is still dictated by the ligand shell, the observed nanoparticle chain was compared to one comprised of idealized nanoparticles with the dimensions of the nanoparticle core and ligand shell drawn to scale (inset. FIG. 3). The nanoparticles in this model are arranged in a close-packed fashion and have the same relative orientation as the original nanoparticle chain. There is good agreement between the model and the original structure. The close agreement between the model and the data can be explained by assuming that the ligand shells of neighboring nanoparticles are in close contact with each other and are not subject to considerable electrostatic repulsion or interdigitation. This also is the case in the defect area where the three nanoparticles form a triangular arrangement rather than a linear structure, indicating that the ligand shell enforces uniform spacing along the complete nanoparticle chain. This non-linearity is probably due to structural defects in the DNA scaffold (e.g. nicks) or to the binding of the nanoparticles to different sides of the DNA. In contrast to other biomolecular lithography systems, (See, Alivisatos, A. P.; Johnsson, K. P.; Peng, X.; Wilson, T. E.; Loweth, C. J.; Bruchez, M. P., Jr.; Schultz, P. G. Nature 1996, 382, 609-611; Mirkin, C. A.; Letsinger, R. L.; Mucic, R. C.; Storhoff, J. J. Nature 1996, 382, 607-609; and Loweth, C. J.; Caldwell, W. B.; Peng, X.; Alivisatos, A. P.; Schultz, P. G. Angew. Chem., Int. Ed. 1999, 38, 1808-1812) where the interparticle spacing is controlled by specific attachments to the template rather than by the close packing of adjacent ligand shells, disclosed embodiments tolerate such defects (i.e. preserves the spacing) allowing for a higher degree of control and uniformity.

Certain embodiments of the nanoparticle assemblies disclosed herein show striking linearity and order over extended distances. Particular examples of such assemblies span up to nearly one micron. FIG. 4 displays an example of such an extended structure of Auₙ-MEMA nanoparticles that stretches a distance of 705 nm. It is remarkably linear over this distance and has uniform interparticle spacing. The nanoparticle chain in this example consists of a total of 167 individual particles with an average interparticle spacing of 2.4±1.2 nm measuring all 166 interparticle distances.

In general, the arrays disclosed herein can be prepared substantially free of defects. However, with reference to the array of FIG. 4, the slightly larger values for the average interparticle spacing and standard deviation in this extended chain are due to defects in the assembly where one or more nanoparticles are missing. Nonetheless, only a total of ten such defects (˜6% of all measurements) is found along the complete chain with interparticle spacing larger than 3.7 nm which corresponds to the size of a missing particle (i.e. the total diameter of one nanoparticle (d_{CORE}=1.6 nm) including the thickness of the MEMA ligand shell). Using this spacing (3.7 nm) as the upper cutoff for the analysis, the average spacing drops to 2.2±0.4 nm which is almost identical to the value reported in FIG. 2. These data demonstrate the high degree of order in such extended structures. The high coverage of this stretch of the DNA scaffold can be calculated using idealized nanoparticles with a total diameter of 3.7 nm as a model (see above). These calculations reveal that the total coverage of the nanoparticle chain shown in FIG. 4 is greater than 50%, such as from about 75% to nearly 90%. The coverage of the DNA strand shown in FIG. 4 was calculated by dividing the number of particles on the nanoparticle chain shown in FIG. 4 by the number of particles on a fully decorated DNA stretch of the same length. A fully decorated DNA strand of a length of 705 nm contains 190 nanoparticles with a total diameter of 3.6 nm. These results clearly illustrate the reliability and robustness of the disclosed approach for preparing extended, linear, uniformly-spaced arrays of nanostructures on DNA scaffolds.

### Ligand Exchange Reaction

This section illustrates the scope and broad utility of the disclosed ligand exchange method for the preparation of a wide range of small (d_{CORE} from about 0.7 nM to about 2 nm, such as ˜1.5 nm), functionalized nanoparticles. Particular examples include functionalization by organic- and water-soluble ligands, including by way of example, optionally functionalized alkyl- or arylthiols (with neutral or charged head groups) to illustrate both the ease of preparation and the surprisingly high tolerance of the disclosed approach to a large variety functional groups (FIG. 1). Also disclosed are convenient, novel purification procedures, the results of complete characterization of these materials, and the important characteristics of the thiol-stabilized nanoparticles produced by the disclosed method.

Also described in this section is an unexpected three-stage mechanism for the ligand exchange. Evidence for such a mechanism is derived from product analysis of the ligand exchange reaction, ³¹P NMR spectroscopy, and trapping experiments to probe for the presence of free PPh₃. The results of these experiments suggest that, initially, the nanoparticles lose triphenylphosphine as AuCl(PPh₃). During the later stages of the exchange, the remaining phosphines are removed as PPh₃ assisted by gold complexes in solution. Demonstrated is an approach to controlling the extent of the ligand exchange. Understanding of this mechanism renders it possible, as disclosed herein, to synthesize nanoparticles with mixed ligand shells of defined, reproducible composition.

### I. Ligand Exchange Reaction

### A. Background

Ligand exchange reactions of 1.5-nm triphenylphosphine-stabilized gold nanoparticles (1.5-nm Auₙ-TPP) with a few ω-functionalized thiols to produce functionalized nanoparticles that preserve the core dimensions of the precursor particles but exhibit highly increased stability against heat, aggregation, and decomposition have been described by Brown, L. O.; Hutchison, J. E. J. Am. Chem. Soc. 1997,119, 12384-12385; Warner, M. G.; Reed, S. M.; Hutchison, J. E. Chem. Mater. 2000,12, 3316-3320; and Weare, W. W.; Reed, S. M.; Warner, M. G.; Hutchison, J. E. J. Am. Chem. Soc. 2000, 122, 12890-12891. The triphenylphosphine-stabilized Au nanoparticles used herein were prepared according to two different procedures by Schmid et al. and by Hutchison et al. Inorg. Syn. 2004, 34, 228-232. Both procedures yield nanoparticles with a core size of 1.5±0.5 nm, and both materials have identical optical properties. With the exception of several biphasic ligand exchanges and the trapping studies, all disclosed embodiments were carried out using particles prepared by both procedures. No differences in reactivity between nanoparticles prepared by the two procedures were observed. Although different chemical compositions have been reported for both materials (i.e., “Au₅₅(PPh₅)₁₂Cl₆” for Schmid's nanoparticles and “Au₁₀₁(PPh₃)₂₁Cl₅” for particles prepared by the Hutchison synthesis), as demonstrated herein both materials have identical reactivity. Therefore both materials are treated referred to herein as 1.5-nm Auₙ-TPP. The development of a convenient synthesis of 1.5-nm Auₙ-TPP has generated considerable interest in the ligand exchange reactions of these nanoparticles. To exploit the full potential of 1.5-nm Auₙ nanoparticles a variety of functionalized nanoparticles were prepared using the present, versatile synthesis protocol.

In the case of ligand exchanges of thiol-stabilized nanoparticles with free thiols, the use of different ligands can lead to changes in core size, incomplete exchange or no exchange at all. Hostetler, M. J.; Green, S. J.; Stokes, J. J.; Murray, R. W. J. Am. Chem. Soc. 1996, 118, 4212-4213; Templeton, A. C.; Cliffel, D. E.; Murray, R. W. J. Am. Chem. Soc. 1999, 121, 7081-7089. Described herein is the characterization of a representative family of functionalized thiols for their compatibility with the ligand exchange procedure (FIG. 1).

Ligand exchange between the 1.5-nm Auₙ-TPP precursor particle and functionalized thiols can be achieved by combining the phosphine-stabilized nanoparticle with an excess of the thiol (approximately 90 to 200 molar equivalents with respect to the nanoparticle) in an appropriate solvent. Organic-soluble exchange products are prepared in a monophasic system (typically using halogenated organic solvents, such as CH₂Cl₂ as the solvent) with a variety of alkyl- and arylthiols. The reaction time strongly depends on the thiol ligand used and generally increases with increasing chain length, ranging from 30 minutes for exchanges with propanethiol up to 18 hours for octadecanethiol (ODT). For aromatic thiols, reactions times are usually longer and typically require more than 12 hours to achieve complete exchange. Without being limited to theory, applicants believe this trend in reactivity can be attributed to steric effects (see, Hostetler, M. J.; Templeton, A. C.; Murray, R. W. Langmuir 1999, 15, 3782-3789).

Water-soluble exchange products can be obtained in a similar fashion using a biphasic solvent system (e.g., CH₂Cl₂-water) in place of the organic solvent. This reaction is applicable for thiols having either neutral or charged (cationic or anionic) functional groups, such as head groups. The trend in reactivity is similar to that of the organic-soluble nanoparticles in that short chain ligands undergo faster ligand exchange than long chain ligands. Interestingly, charged ligands generally require considerably shorter reactions times than uncharged ligands in the biphasic reactions. This is possibly due to increased solubility of the partially exchanged particle in the aqueous layer.

As summarized in FIG. 1, the reaction is generally applicable for a wide range of different aliphatic and aromatic thiols and tolerates a surprisingly large number of functional groups including charged or polar head groups, such as alcohols, carboxylates, sulfonic acid, phosphonic acid, and ammonium salts. The ligands can be aliphatic or aromatic thiols having optional substitutions. Examples of aliphatic thiols include those having alkylene chains of from about 2 to about 22 carbons, typically from 2 to about 18 carbons. Such alkylene chains can be optionally interrupted with one or more heteroatoms, such as oxygen. For example, such chains can include one or more ethylene glycol and/or propylene glycol units. In certain embodiments the thiol ligand includes one or more ionizable groups, such as an amine, guanidine or acid moiety, for example a sulfonic, phosphonic or carboxylic acid moiety. In certain embodiments such ionizable groups are at the distal end of the ligand from the sulfhydryl functional group. Aromatic ligands include optionally substituted aromatic ligands as well as heteroaromatic ligands. In particular embodiments aryl ligands include one or more phenyl groups, such as a biphenyl group. Of the 22 functionalized thiols tested, all were compatible with the disclosed approach, and none resulted in significant core size changes. Most thiols can be exchanged by following the standardized procedures disclosed herein for either monophasic- or bi-phasic reactions. Only a few thiols (e.g., mercaptophenol, mercaptoethanesulfonic acid) required special reaction conditions to achieve complete exchange mainly related to solubility differences between the precursor particle and the exchange product.

### B. Reaction Conditions for Ligand Exchange

Successful ligand exchange can be controlled by a few general experimental parameters to ensure completion of the ligand exchange and avoid decomposition of the 1.5-nm Auₙ-TPP precursor particle. The reaction proceeds to completion when an excess of the incoming thiol is used (in certain embodiments approximately 90 to 200 molar equivalents with respect to the nanoparticle is used; this stoichiometry works for most thiols). Smaller amounts of thiol usually result in incomplete exchange. On the other hand, if too large an excess of thiol is used (more than 300 molar equivalents in most cases) the phosphine-stabilized nanoparticles rapidly decompose rather than undergoing ligand exchange. Lin, S.-Y.; Tsai, Y.-T.; Chen, C.-C.; Lin, C.-M.; Chen, C.-h. J. Phys. Chem. B 2004, 108, 2134-2139. Decomposition is also observed when the exchange reaction is carried out at elevated temperatures presumably due to the limited thermal stability of the phosphine-stabilized precursor particles in solution.

In the case of biphasic ligand exchange reactions, typically the pH of the aqueous phase is close to neutral (ideally between pH 5 and 8). Under more acidic conditions (pH 4 and lower) the 1.5-nm Auₙ-TPP precursor particles undergo rapid decomposition, greatly reducing the yield of the reaction or preventing ligand exchange completely. At high pH, significant disulfide formation can interfere with ligand exchange unless the reaction is carried out under vigorously oxygen-free conditions. For ligands with acid head groups the ligand exchange is performed at pH at which such head groups are substantially ionized, to prevent the formation of an insoluble nanoparticle material at the solvent interface consisting of incompletely exchanged nanoparticles. By using slightly basic conditions for the ligand exchange reaction, the formation of insoluble material is avoided and the exchange reaction proceeds to completion. For example, the best results for carboxylic acid terminated alkylthiols (e.g., 3-mercaptopropionic acid) were obtained using a buffered aqueous phase (KH₂PO₄/K₂HPO₄, pH 8). These conditions are basic enough to facilitate the reaction but still close enough to neutral pH to avoid significant disulfide formation (appreciable disulfide formation causes incomplete ligand exchange).

### C. Purification of the Exchange Products

A convenient and rapid purification procedure is disclosed herein that renders the disclosed ligand exchange approach of broad utility. For a number of applications and studies, high purity nanoparticle samples are employed. High purity in investigating structure-function relationships keeps small amounts of impurities from skewing the results. Thus, the presently disclosed, reliable purification methods, which are both rapid and convenient and afford high purity products, represent a significant advance. Previously, (Brown, L. O.; Hutchison, J. E. J. Am. Chem. Soc. 1997, 119, 12384-12385) the exchange products were purified through a series of precipitations and/or solvent washes. This purification method is usually sufficient to remove by-products and impurities (such as excess free ligand and residual gold salts) but it always leads to a noticeable loss of product. Moreover, it is typically necessary to tailor this method to the solubility characteristics and functional groups of each new nanoparticle making this approach time-consuming, inconvenient, and inefficient.

A more general approach involves the use of gel filtration chromatography, using a suitable gel filtration, such as a Sephadex resin. In particular examples, gel filtration chromatography was performed using Sephadex LH-20. With this approach, almost complete recovery of the nanoparticle material is achieved, and excess free ligand, by-products, and residual gold salts can be removed in a rapid and efficient fashion. The versatility of the column material allows purification of all exchange product nanoparticles in a wide range of solvents including chlorinated solvents, alcohols, and water using the same support. Therefore, this technique is applicable for both organic- and water-soluble exchange products. Furthermore, the column material can be routinely reused after sufficient rinsing with an appropriate solvent, reducing cost and preventing waste.

For water-soluble exchange products, it is also possible to exploit ultracentrifugation for purification. In working embodiments at 360,000×g, the particles formed an oily pellet at the bottom of the tube (after approximately 12 hours of centrifugation) which can be separated from the supernatant to remove molecular impurities. Further purification can be accomplished by mixing the pellet with water and repeating the centrifugation process. In certain embodiments plural cycles of centrifugation are performed, working embodiments typically used two cycles of centrifugation. Usually ˜90-95% of the supernatant can be separated from the oily pellet following each centrifugation before losing a significant amount of product.

### D. Characterization of the Exchange Products

The thiol-stabilized exchange products were characterized using a combination of analytical tools including NMR, UV-vis spectroscopy, TEM, TGA, and XPS. Analytical data for exemplary thiol-stabilized nanoparticles are summarized in Table 1.

TABLE 1
Analytical Data for the Ligand Exchange Products

| | | | Molar | | | | |
|---|---|---|---|---|---|---|---|
| | | | equivalents of | | ¹H NMR chemical | | % |
| | Reaction | | thiol relative to | | shift (ppm) and | Au:S | ligand |
| Ligand | time | | nanoparticles | d_{CORE} ^{a} | NMR solvent | ratio ^{b} | by mass ^{c} |
| HS(CH₂)₂CH₃ ^{d} | 30 | min | 200 | 1.5 ± 0.4 | 1.07 (b) CDCl₃ | 2.3 | 15.4 |
| | | | | (N = 952) | 1.88 (b) | | |
| HS(CH₂)₅CH₃ ^{d} | 4 | h | 200 | 1.5 ± 0.3 | 0.90 (b) CDCl₃ | 2.3 | 20.5 |
| | | | | (N = 1281) | 1.32 (b) | | |
| | | | | | 1.80 (b) | | |
| HS(CH₂)₉CH₃ ^{d} | 8 | h | 150 | 1.4 ± 0.4 | 0.90 (b) CDCl₃ | 2.3 | 27.4 |
| | | | | (N = 786) | 1.27 (b) | | |
| HS(CH₂)₁₁CH₃ ^{d} | 10 | h | 125 | 1.6 ± 0.3 | 0.91 (b) CDCl₃ | 2.3 | 30.3 |
| | | | | (N = 1180) | 1.26 (b) | | |
| HS(CH₂)₁₅CH₃ ^{d} | 15 | h | 100 | 1.6 ± 0.4 | 0.89 (b) CDCl₃ | 2.3 | 35.0 |
| | | | | (N = 1024) | 1.27 (b) | | |
| HS(CH₂)₁₇CH₃ ^{d} | 18 | h | 90 | 1.6 ± 0.5 | 0.90 (b) CDCl₃ | 2.4 | 37.1 |
| | | | | (N = 945) | 1.26 (b) | | |
| 4-mercaptophenol ^{d} | 12 | h ^{e} | 200 | 1.4 ± 0.4 | 7.23 (b) CD₃OD | 2.7 | 20.1 |
| | | | | (N = 1202) | | | |
| 4-mercaptotoluene ^{d} | 12 | h | 200 | 1.5 ± 0.5 | 2.21 (b) CDCl₃ | 2.8 | 21.3 |
| | | | | (N = 647) | 7.03 (b) | | |
| 4-mercaptobiphenyl ^{d} | 18 | h | 140 | 1.6 ± 0.3 | 7.20 (b) CDCl₃ | 2.7 | 25.5 |
| | | | | (N = 837) | | | |
| HS(CH₂)₃Si(OCH₃)₃ ^{d} | 6 | h | 130 | 1.6 ± 0.4 | 3.59 (b) CD₃OD | 2.5 | 28.1 |
| | | | | (N = 771) | 3.82 (b) | | |
| HS(CH₂)COOH ^{f} | 2 | h | 200 | 1.5 ± 0.3 | 3.30 (b) CD₃OD | 2.5 | 16.4 |
| | | | | (N = 1281) | | | |
| HS(CH₂)₂COOH ^{f} | 2 | h | 180 | 1.5 ± 0.3 | 2.90 (b) CD₃OD | 2.6 | 17.5 |
| | | | | (N = 821) | | | |
| HS(CH₂)₅COOH ^{f} | 4 | h | 170 | 1.5 ± 0.4 | 2.70 (b) CD₃OD | 2.7 | 22.6 |
| | | | | (N = 673) | | | |
| HS(CH₂)₁₁COOH ^{f} | 7 | h | 110 | 1.4 ± 0.3 | 1.35 (b) CD₃OD | 2.9 | 30.6 |
| | | | | (N = 592) | 1.61 (b) | | |
| | | | | | 2.28 (b) | | |
| HS(CH₂)₂O(CH₂)₂OH ^{f} | 6 | h | 200 | 1.5 ± 0.5 | 3.70 (b) D₂O | 2.9 | 18.7 |
| | | | | (N = 923) | | | |
| HS(CH₂)₂O(CH₂)₂O(CH₂)₂OH ^{f} | 8 | h | 155 | 1.6 ± 0.4 | 3.75 (b) D₂O | 3.1 | 21.9 |
| | | | | (N = 867) | | | |
| HS(CH₂)₂PO(OH)₂ ^{f} | 5 | h | 180 | 1.6 ± 0.4 | 3.31 (b) D₂O | 2.9 | 18.8 |
| | | | | (N = 1045) | | | |
| HS(CH₂)₂NMe₂•HCl ^{f} | 1 | h | 180 | 1.4 ± 0.6 | 2.90 (b) D₂O | 2.8 | 20.8 |
| | | | | (N = 581) | 3.52 (b) | | |
| HS(CH₂)₂NMe₃⁺Cl⁻ ^{f} | 3 | h | 165 | 1.6 ± 0.5 | 3.34 (b) D₂O | 2.8 | 23.6 |
| | | | | (N = 843) | 3.74 (b) | | |
| HS(CH₂)₂O(CH₂)₂NMe₃⁺Cl⁻ ^{f} | 4 | h | 130 | 1.6 ± 0.5 | 3.21 (b) D₂O | 2.7 | 28.4 |
| | | | | (N = 732) | 3.62 (b) | | |
| HS(CH₂)₂O(CH₂)₂O(CH₂)₂NMe₃⁺Cl⁻ ^{f} | 5 | h | 95 | 1.6 ± 0.4 | 3.20 (b) D₂O | 2.7 | 31.7 |
| | | | | (N = 853) | 3.61 (b) | | |
| | | | | | 3.90 (b) | | |
| HS(CH₂)₂SO₃⁻Na⁺ ^{g} | 12 | h | 155 | 1.5 ± 03 | 3.31 (b) D₂O | 2.6 | 25.1 |
| | | | | (N = 1281) | | | |

^{a} Core diameter in nm (mean ± std dev) from analysis of representative TEM images. N refers to the number of particles measured.
^{b} Ratio obtained from quantification of the areas of the XPS signals.
^{c} Obtained from TGA analysis.
^{d} Synthesized according to the general procedure for the preparation of organic-soluble nanoparticles.
^{e} The reaction is carried out in CH₂Cl₂ for 8 h until a black precipitate is formed. The solvent is replaced with methanol and the mixture stirred for an additional 4 h.
^{f} Synthesized according to the general procedure for the preparation of water-soluble nanoparticles.
^{g} This material is obtained in a two-step synthesis as described by Hostetler, M. J.; Templeton, A. C.; Murray, R. W. Langmuir 1999, 15, 3782-3789.

The purity of the exchange products was confirmed by ¹H NMR in which the absence of sharp resonances precludes the presence of excess free ligand and residual gold salts (e.g., AuCl(PPh₃) and higher coordinated Au(I) complexes Attar, S.; Bearden, W. H.; Alcock, N. W.; Alyea, E. C.; Nelson, J. H. Inorg. Chem. 1990, 29, 425-433.). Terrill et al. J. Am. Chem. Soc. 1995, 117, 12537-12548. For exchanges involving non-aromatic thiols, ¹H NMR can also be used to confirm that the exchange proceeds to completion (as indicated by the absence of the broad aromatic resonance due to the gold-bound phosphines). Sometimes (especially in monophasic exchanges using organic-soluble thiols) a small broad signal centered around 7.5 ppm can be seen which corresponds to unexchanged phosphines or AuCl(PPh₃) impurities. Based upon integration of the NMR signals, less than ˜3% phosphines (with respect to the thiols) are present in these cases. XPS analysis shows only trace amounts of AuCl(PPh₃) (based upon the Au 4f signal) with no detectable phosphorous signal. Free thiol cannot be detected by NMR spectroscopy after successful purification.

The particle core size initially was assessed by UV-vis spectroscopy. The absence of a plasmon resonance in the optical spectra of the exchange products is consistent with the preservation of the small core size (<2 nm) of the phosphine-stabilized precursor particle. This inference is confirmed by measurement of the core sizes from representative TEM images of the nanoparticles. Brown, L. O.; Hutchison, J. E. J. Phys. Chem. B 2001, 105, 8911-8916. A typical average core size for the exchanged particles (from N>500 particles per sample) is approximately 1.5±0.4 nm (Table 1).

Finally, the chemical composition was quantified by a combination of XPS and TGA. The absence of phosphorous and chlorine signals in the XPS analysis suggests that the ligand exchange reactions were complete and that all phosphine-containing by-products have been removed. (The only exception noted to date are the mercaptoethanesulfonate-stabilized nanoparticles, which only partially exchange as reported earlier. Warner, M. G.; Reed, S. M.; Hutchison, J. E. Chem. Mater. 2000, 12, 3316-3320. However, in this case the ligand exchange can be driven to completion in a subsequent step using a 1:1 water/THF mixture).

Quantitative XPS analyses give gold-to-sulfur ratios varying from 2.3:1.0 to 3.1:1.0 depending on the ligand. In all cases, these ratios are in good agreement with ratios obtained by TGA. Under the assumption that the nanoparticle core corresponds to approximately one hundred gold atoms (Weare, W. W.; Reed, S. M.; Warner, M. G.; Hutchison, J. E. J. Am. Chem. Soc. 2000,122, 12890-12891), the composition of 1.5-nm Auₙ-TPP nanoparticles is approximately Au₁₀₁(PPh₃)₂₁Cl₅. This is in good agreement with theoretical calculations that give 104 core atoms for a 1.5-nm Au particle (using a spherical core geometry). These ratios correspond to an average number of 32-45 thiol ligands per nanoparticle. Using a spherical model for the nanoparticle surface and a footprint for a thiol ligand of ˜0.214 nm² (a typical value for alkylthiol SAMS), the surface coverage of the nanoparticles with thiols varies between 78 and 108%. This estimate does not take into account that the different thiols presumably have different footprints and that there are different binding sites on the nanoparticle surface (planes, edges, vertices). For example, a thiol may have a smaller footprint near a facet edge than on a flat surface. Qualitatively, nanoparticles stabilized with bulkier aromatic thiols and thiols with functional groups (either internal or peripheral) exhibit lower surface coverage than non-functionalized alkylthiols.

Thiol-stabilized ligand exchange products obtained according to certain embodiments of the present method possess a number of highly desirable properties that set them apart from their phosphine-stabilized precursors and other thiol-stabilized nanoparticles. Disclosed embodiments yield nanoparticles that exhibit a high stability that is comparable to other thiol-stabilized nanoparticles. As monitored by UV-vis spectroscopy, the particles do not show any noticeable degradation in solution over extended periods of time (up to several weeks) and can be heated in solution at 75° C. for over 9 h. See, Brown, L. O.; Hutchison, J. E. J. Am. Chem. Soc. 1997, 119, 12384-12385; and Warner, M. G.; Reed, S. M.; Hutchison, J. E. Chem. Mater. 2000, 12, 3316-3320. These references are incorporated herein by reference. In addition, the water-soluble exchange products reported here show good stability over a wide pH range (typically pH 1-12) and towards high salt conditions (See, Warner, Chem. Mater. 2000, supra) which makes them suitable for a wide range of applications. This represents a remarkable stability increase in comparison to the phosphine-stabilized precursors which rapidly decompose in solution to (predominantly) AuCl(PPh₃) and Au(0) within a few hours. Schmid, G.; Pfeil, R.; Boese, R.; Brandermann, F.; Meyer, S.; Calis, G. H. M.; Van der Velden, J. W. A. Chem. Ber. 1981, 114, 3634-3642.

In addition, embodiments of the method described herein allow for complete ligand exchange, generating thiol-stabilized nanoparticles with a ligand shell containing only one type of thiol, if desired. This is in contrast to previous ligand exchange approaches, including thiol-for-thiol ligand exchange reactions, which typically result in mixed ligand shells. See, for example, Hostetler, M. J.; Templeton, A. C.; Murray, R. W. Langmuir 1999, 15, 3782-3789; Ingram, R. S.; Hostetler, M. J.; Murray, R. W. J. Am. Chem. Soc. 1997, 119, 9175-9178. Deliberate access to mixed ligand shell compositions, can be achieved by using a feedstock of different thiols during the exchange reaction or using an insufficient amount of thiol to complete the ligand exchange. It is also possible to produce mixed ligand shells by using disulfides instead of thiols (Wellsted, H.; Sitsen, E.; Caragheorgheopol, A.; Chechik, V. Anal. Chem. 2004, 76, 2010-2016).

Finally, the small core dimension and narrow size dispersity of the precursor particles is essentially preserved in the exchange products as synthesized. In certain embodiments, a small amount of gold atoms (˜5%) is lost during the exchange reaction. However, this loss of core atoms results only in an immeasurable change in the particle core diameter. This preservation of dimension and dispersity renders the method suitable for preparing nanoparticles for electronic and optical applications that benefit from convenient access to a diverse family of functionalized nanoparticles with controlled physical properties (Berven, C. A.; Clark, L.; Mooster, J. L.; Wybourne, M. N.; Hutchison, J. E. Adv. Mater. 2001, 13, 109-113).

### E. Mechanistic Considerations

The mechanism of the ligand exchange reactions described above is illustrated using Auₙ-TPP and ODT as an exemplary system. The mechanism was monitored by NMR spectroscopy to monitor each species throughout the course of the reaction. These data are accompanied by trapping experiments designed to probe the fate of the exchanged PPh₃ ligands. A second series of NMR experiments gives detailed insight into the progression of the ligand exchange. The results of this study can be used in combination with the product analysis studies to control the ligand shell composition of the nanoparticles by partially blocking the exchange. A three-stage mechanistic model for the ligand exchange based upon the experimental evidence is set forth below. A complicating factor for the following mechanistic discussion is that samples of 1.5-nm Auₙ-TPP always contain trace amounts of AuCl(PPh₃), which can be seen in the UV-visible spectrum. However, the ³¹P NMR spectrum does not show any peaks, suggesting that the amount of AuCl(PPh₃) is either too small to be detected by NMR or that it is involved in an exchange reaction with the nanoparticle. It is possible that the rapid formation of phosphine-rich mixtures of AuCl(PPh₃) described below could be caused in part by the presence of AuCl(PPh₃) in the nanoparticle sample.

During initial characterization of the ligand exchange reaction between 1.5-nm Auₙ-TPP and thiols, AuCl(PPh₃) and poly-phosphine Au(I) complexes (i.e., (PPh₃)ₙAuCl) were the main identifiable phosphine-containing products of the ligand exchange. A complicating factor for the following mechanistic discussion is that samples of 1.5-nm Auₙ-TPP contain trace amounts of AuCl(PPh₃) that can be seen in the UV-visible spectrum. However, the ³¹P NMR spectrum does not show any peak, suggesting that the amount of AuCl(PPh₃) is either too small to be detected by NMR or that it is involved in an exchange reaction with the nanoparticle. It is possible that the rapid formation of phosphine-rich mixtures of AuCl(PPh₃) described below could be caused in part by the presence of AuCl(PPh₃) in the nanoparticle sample.

Free PPh₃ was not found in the reaction mixture. This was unexpected because, for a simple ligand exchange reaction, one might expect that the phosphine ligands dissociate as free PPh₃. This suggested that thiol-for-phosphine exchange reactions follow a significantly different mechanism than thiol-for-thiol exchanges. A series of ³¹P NMR spectroscopy experiments were employed to elucidate the detailed mechanism for the replacement of the phosphine ligands.

The ligand exchange between 1.5-nm Auₙ-TPP and ODT was first performed using an excess of the thiol (90 molar equivalents ODT with respect to the nanoparticle) to ensure complete exchange. Immediately after addition of ODT to the nanoparticle solution (˜1 min), AuCl(PPh₃) was produced as the only observable phosphine-containing species with its characteristic phosphorus chemical shift of 32.9 ppm. The formation of AuCl(PPh₃) as the leaving group of the ligand exchange reaction explains the absence of chlorides in the thiol-stabilized nanoparticles but does not account for all of the phosphine ligands that are replaced by the incoming thiol ligands. The ³¹P NMR spectrum of the crude reaction mixture after completion of the exchange showed a single, broadened peak at 24.7 ppm. Free PPh₃ was not observed at any stage of the reaction. Even deliberate addition of free PPh₃ to the reaction mixture after completion of the ligand exchange did not lead to the appearance of a resonance for free PPh₃ in the ³¹P NMR spectrum. Instead, the broadened peak at 24.7 ppm shifted further upfield with increasing addition of free PPh₃.

To understand the results from the product analysis studies, it is important to elucidate the nature of the observed line broadening in the ³¹P NMR spectra. Line broadening has been observed previously in a number of other studies that investigated the dynamics of ligand exchanges in solutions containing phosphine-stabilized nanoparticles (Petroski, J.; Chou, M. H.; Creutz, C. Inorg. Chem. 2004, 43, 1597-1599; chmid, G. Struct. Bonding 1985, 62, 51-85) and Au(I)-phosphines (Alyea, E. C.; Malito, J.; Attar, S.; Nelson, J. H. Polyhedron 1992, 11, 2409-2413). Based upon these studies and those disclosed herein, it appears that at least two types of reactions can lead to line broadening: (i) exchange between PPh₃ and the phosphine-stabilized nanoparticles, and (ii) exchange between PPh₃ and AuCl(PPh₃).

It was recently reported that addition of 1.5-nm Auₙ-TPP to a solution of PPh₃ leads to line broadening and a downfield shift of the ³¹P NMR resonance of PPh₃ (Petroski, J.; Chou, M. H.; Creutz, C. Inorg. Chem. 2004, 43, 1597-1599). The line broadening was explained as a slow ligand exchange between 1.5-nm Auₙ-TPP and PPh₃ (the exchange rate was assumed to be in the millisecond regime). The authors also considered that the broadening could be due to the exchange of PPh₃ with AuCl(PPh₃) (always present as an impurity in samples of PPh₃-stabilized nanoparticles) but concluded that this exchange is too rapid and should lead to line narrowing. This conclusion was based upon studies by Schmid et al. who estimated this exchange to be in the microsecond regime. However, the results described herein suggest that the exchange reaction between PPh₃ and AuCl(PPh₃) leads to line broadening, not to line narrowing. Thus, it appears that ligand exchange between 1.5-nm Auₙ-TPP and PPh₃ may be more complex, possibly involving AuCl(PPh₃) in the exchange chemistry. In the present study, thiols bind to the nanoparticle surface preventing the exchange between PPh₃ or AuCl(PPh₃) with the nanoparticle; thus, the observed line broadening is solely due to the exchange between PPh₃ and AuCl(PPh₃) in the phosphine-rich mixture of AuCl(PPh₃) produced as result of the ligand exchange. Based upon the ³¹P NMR chemical shift of the mixture, we can estimate a ratio between PPh₃ and AuCl(PPh₃) of approximately 2.5:1 at the end of the exchange.

A trapping experiment was performed to assay PPh₃ in solution. The trapping species selected was 1-azido-2,4-dinitrobenzene because it rapidly undergoes a Staudinger reaction with PPh₃ resulting in an iminophosphorane that is easily observable by NMR (see Scheme 1).

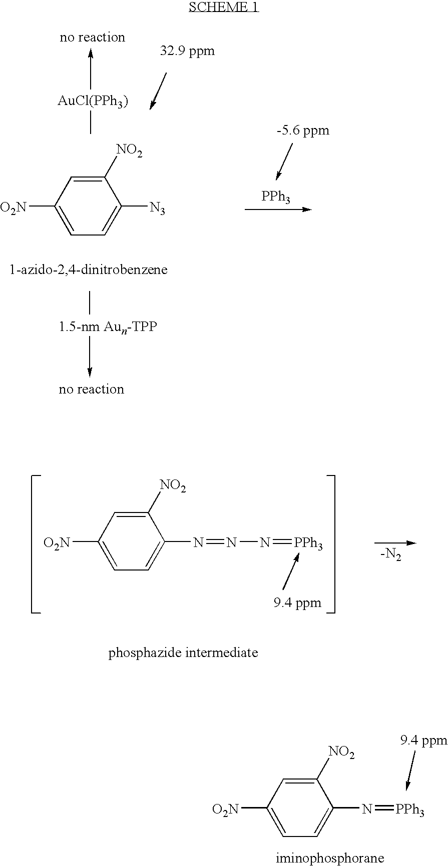

A series of control experiments was performed to test the ability of the azide (1-azido-2,4-dinitrobenzene) to trap PPh₃ in the presence of AuCl(PPh₃), phosphine-stabilized nanoparticles, alkylthiols and phosphine-rich mixtures of AuCl(PPh₃). Upon addition of PPh₃ to a solution of AuCl(PPh₃) and the azide, the iminophosphorane (via the phosphazide) was immediately formed and observed as two signals in the ³¹P{¹H} NMR spectrum—one corresponding to AuCl(PPh₃) (δ=32.9 ppm), and one to the iminophosphorane (δ=9.4 ppm). No formation of [Au(PPh₃)₂]⁺Cl⁻ was observed in this situation. In contrast, the azide shows no noticeable reaction with solutions of the 1.5-nm Auₙ-TPP, AuCl(PPh₃), or ODT over the course of several hours. The azide reacts with phosphine-rich mixtures of AuCl(PPh₃) more slowly and only when an excess of PPh₃ (>1 eq.) is present. These controls show that in a competition experiment, free PPh₃ reacts much faster with the azide than it does with AuCl(PPh₃). However, if PPh₃ is part of a preexisting phosphine-rich mixture with AuCl(PPh₃), the azide is unable to compete with AuCl(PPh₃) for PPh₃.

When 1-azido-2,4-dinitrobenzene is added to the ligand exchange mixture of 1.5-nm Auₙ-TPP and ODT, free ODT is consumed (as indicated by the disappearance of the methylene resonances closest to the sulfur); confirming that the course of the exchange reaction is unaffected by the presence of the azide. Although the ligand exchange proceeds immediately, the azide remains unreacted, until near the end of the reaction when some iminophosphorane is formed. This means that free PPh₃ is not present in solution during the early stages of the reaction. The iminophosphorane produced near the end of the exchange is likely due to the reaction of the azide with the phosphine-rich Au(I) mixture (i.e., mixtures of AuCl(PPh₃) containing PPh₃) that builds up as the reaction proceeds.

A similar product distribution is observed for the decomposition of 1.5-nm Auₙ-TPP in the absence of thiol. Decomposition of 1.5-nm Auₙ-TPP most likely results in the formation of Au(0) and AuCl(PPh₃). As the nanoparticle decomposes in solution, the UV-visible spectrum displays an increase in absorbance between 230 and 300 nm consistent with the formation AuCl(PPh₃). However, as in the case of thiol-for-phosphine ligand exchange reactions, AuCl(PPh₃) can not be the only phosphine-containing product given the phosphine-rich composition of the particle. Trapping studies (to trap free PPh₃) show similar results to thiol-for-phosphine ligand exchange studies and indicate that PPh₃ is not present in solution at any time during decomposition. Instead, the ³¹P NMR spectrum shows a single, slightly broadened peak that indicates the presence of poly-phosphine Au complexes (Alyea, E. C.; Malito, J.; Attar, S.; Nelson, J. H. Polyhedron 1992, 11, 2409-2413).

If the remaining phosphine ligands are liberated from the nanoparticle as free PPh₃, one would expect immediate formation of iminophosphorane because the trapping reagent is used in excess and reacts much faster with PPh₃ than does AuCl(PPh₃). The lack of iminophosphorane formation until late in the ligand exchange strongly suggests that free PPh₃ is not present in solution. Instead, these results are more consistent with a scenario in which AuCl(PPh₃) (or polyphosphine complexes) associates with the nanoparticle surface and assists directly in the removal of the remaining phosphine ligands, resulting in the formation of polyphosphine Au complexes. In this situation, free PPh₃ is not available in solution and therefore does not react with the azide. The formation of iminophosphorane product towards the end of the reaction results because the excess of PPh₃ over AuCl(PPh₃) becomes high enough so that PPh₃ can be removed from the phosphine-rich AuCl(PPh₃) mixture by the trap. This is in agreement with the observation that the azide forms iminophosphorane with phosphine-rich mixtures of AuCl(PPh₃) very slowly.

The product analysis and trapping studies give important insight into the fate of the phosphines during the ligand exchange process. The experimental evidence suggests that the ligand exchange involves several different stages and is not a simple substitution of the phosphine ligands by thiols. For clarity of the following discussion, we divide ligand exchange into three defined, separate stages. However, one can expect that these stages overlap to a certain extent rather than being strictly separated in time.

To gain a more detailed understanding about the progression of the ligand exchange, the ligand exchange was monitored in real time. These studies should not only be interesting from a fundamental point of view but could also provide valuable information that would allow for better control of the ligand exchange.

Due to significant differences between the ¹H NMR spectra of ligand-stabilized nanoparticles and those of the free ligands, NMR spectroscopy can differentiate between unbound free ligand and gold-bound ligand. In comparison to free thiols, the spectrum of thiol-stabilized Au nanoparticles shows significant broadening and a downfield shift for the two methylene resonances closest to the sulfur, as well as a general broadening for the methylene resonances in the chain (Terrill et al. J. Am. Chem. Soc. 1995, 117, 12537-12548).

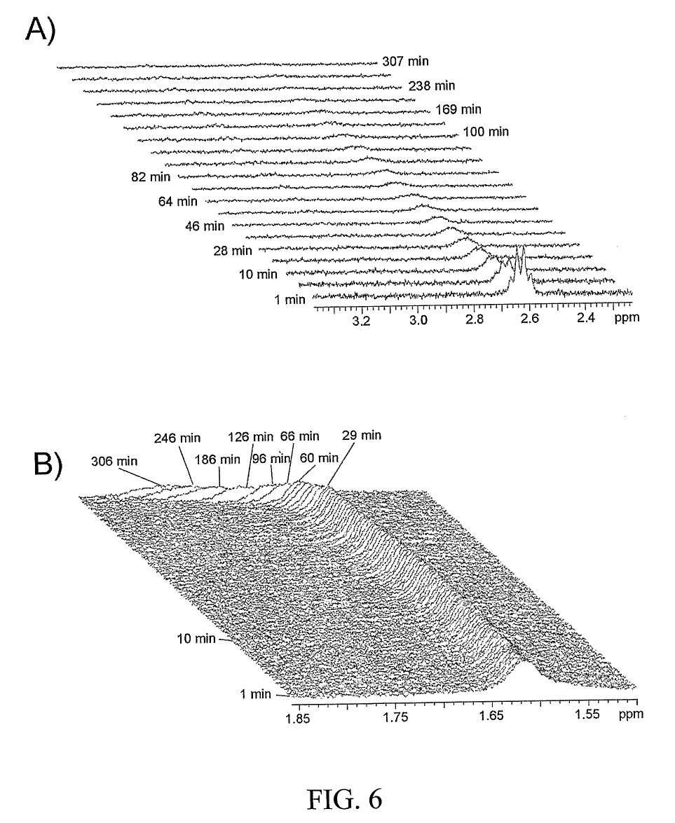

To follow the progression of the exchange reaction by ¹H NMR spectroscopy, we performed a ligand exchange experiment for the reaction of 1.5-nm Auₙ-TPP with approximately enough ODT necessary to replace all phosphine ligands. The solution was monitored until no more changes were observed in the ¹H NMR spectrum, indicating terminal progression of the exchange. Based upon the NMR data, we found that the reaction can be divided into three stages that are each accompanied by changes in the ¹H NMR spectrum. The ¹H NMR spectra are provided in FIGS. 6A and 6B.

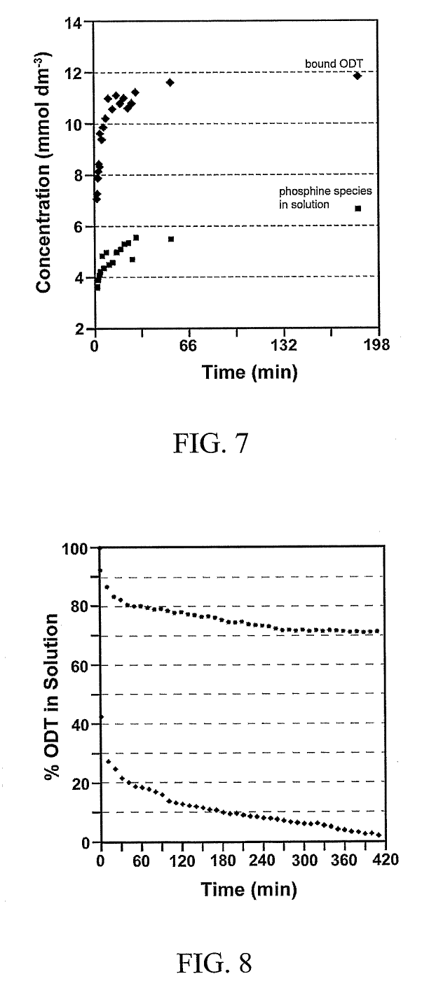

During the initial 1-2 minutes of the reaction (stage 1), the intensity of the a-methylene signal rapidly decreases as ODT is removed from solution and adsorbed onto the nanoparticle surface (FIG. 6A). At the same time, a corresponding increase in the concentration of phosphine species in solution is observed, and the ³¹P NMR spectrum immediately shows a peak at 32.9 ppm which is characteristic of AuCl(PPh₃). FIG. 7 charts the concentration profiles of ODT bound to the nanoparticle and phosphine-species in solution. During the first 1-2 minutes of the exchange, almost half of the total amount of the phosphine species is already liberated. This is consistent with the rapid loss of the total amount of AuCl(PPh₃) and partial removal of the remaining phosphine ligands in the form of Au(I) complexes as described above.

After this initial, fast phase of the reaction, the thiol ligand shell is slowly completed over the course of ˜60 min which can be followed by a linear downfield shift of the β-methylene protons over time (FIG. 6B). During this period, the α-methylene protons are completely broadened into the baseline. The concentration profiles show that during this time interval the increase in the phosphine concentration drastically slows down, indicating that essentially all phosphines have been removed from the nanoparticle (FIG. 7).

During the final, third stage of the exchange reaction (between ˜60 min and the final measurement), the splitting of the β-methylene resonance becomes significantly more pronounced, leading to a further broadening of the peak combined with a continued downfield shift (FIG. 6B). The ligand exchange is most likely complete at this stage although some exchange might still take place. The concentration profiles in FIG. 7 only show minimal changes in the amount of phosphine species in solution and bound ODT.

The change is most likely caused by reorganization of ODT into a more crystalline state with specific associated chemical environments for the ligands. This may involve rearrangement of chemisorbed thiolates or loss of hydrogen in a conversion from physisorbed thiol to chemisorbed thiolate. The fate of the thiol hydrogen is still a subject of speculation within the literature, but recent experiments show that it is possible to adsorb intact thiols onto Au nanoparticles (with subsequent hydrogen removal) under certain conditions. See, Hasan, M.; Bethell, D.; Brust, M. J. Am. Chem. Soc. 2002, 124, 1132-1133. Rearrangement of chemisorbed thiols may help explain the increased reaction time necessary for longer chain thiols. It is quite likely that these processes are also accompanied by a slight rearrangement of the gold core initiated by the loss of Au atoms in the production of AuCl(PPh₃). The observed splitting of the β-methylene signal is believed to correspond to differing binding sites for the thiolates (e.g., faces, edges, and vertices). See, Badia, A.; Gao, W.; Singh, S.; Demers, L.; Cuccia, L.; Reven, L. Langmuir 1996, 12, 1262-1269.

All of the experiments described so far suggest that part of the phosphine ligand shell is replaced in form of AuCl(PPh₃) and not as PPh₃ during the initial stage of the ligand exchange. The remainder of the PPh₃ is lost during later stages of the exchange reaction by a different mechanism involving assisted removal of the ligands by gold complexes in solution. These results pose two fundamental questions: (i) what limits the production of AuCl(PPh₃) and leads to a change in mechanism, and (ii) can this change in mechanism be used to control the extent of ligand exchange by specifically inhibiting part of the exchange reaction.

To answer these two questions, the replacement of the phosphines as PPh₃ was blocked by performing an exchange reaction between ODT and 1.5-nm Auₙ-TPP in the presence of an excess of PPh₃. Addition of an excess of PPh₃ to the reaction mixture should specifically inhibit the loss of PPh₃ during the later stages of the ligand exchange (as this stage is dependent on the concentration of PPh₃). Loss of AuCl(PPh₃) during the first stage should not be affected because the formation of AuCl(PPh₃) is presumably independent of the concentration of free PPh₃ in solution. The extent of inhibition should allow quantification of the relative amount of AuCl(PPh₃) produced and give insight into what is the limiting factor for the production of AuCl(PPh₃).

The exchange reaction between ODT and 1.5-nm Auₙ-TPP was carried out as described in the previous section but with the addition of a four-fold molar excess of PPh₃ over the amount of ODT. The amount of ODT was chosen to just replace all nanoparticle-bound phosphine ligands. We followed the reaction by ¹H NMR spectroscopy and compared it to an identical reaction of ODT with 1.5-nm Auₙ-TPP but without adding PPh₃.

The results are summarized in FIG. 8, which shows the percentage of ODT in solution over time. The ratio between the integrals of the a-CH₂ (closest to the sulfur) and the terminal CH₃ was used as a measure for the amount of ODT in solution. The signal for the a-CH₂ protons disappears when the ligand is bound to the gold surface whereas the intensity of the signal for the terminal CH₃ remains unchanged. Without addition of PPh₃ (FIG. 8, ♦) the percentage of unbound ODT rapidly decreases by approximately 60% during the first minute of the reaction (first measurement). The exchange process slows down as the reaction progresses and is complete after approximately 400 minutes at which time essentially all ODT has been consumed. The situation changes dramatically when an excess PPh₃ is added to the exchange reaction (FIG. 8, ). The percentage of free ODT still shows a rapid decrease during the first minutes of the reaction indicating that the initial stages of the exchange remain largely unaffected by the addition of PPh₃. However, the consumption of free ODT during this initial phase is significantly less than in the absence of PPh₃ (˜15% ODT is immediately consumed). The amount of free ODT in solution slowly stabilizes at approximately 70% after the first 300 minutes of the reaction indicating that no more thiols are being adsorbed onto the nanoparticle.

The resulting partial inhibition of the ligand exchange by the addition of an excess of PPh₃ is consistent with the observation that AuCl(PPh₃) leaves the nanoparticle as an entity during the first stage of the exchange followed by the loss of PPh₃. Based upon the extent of ligand exchange still occurring in the presence of excess PPh₃, we can further conclude that the limiting factor for the production of AuCl(PPh₃) is the number of chlorides (i.e., 5 Cl⁻) initially contained in the ligand shell of the phosphine-stabilized precursor nanoparticle. Given the average chemical composition of the nanoparticle (“Au₁₀₁(PPh₃)₂₁Cl₅”) it is expected that approximately 25% of the phosphine ligands can be replaced in form of AuCl(PPh₃) before all chloride ligands are used up. This is in good agreement with the data presented in FIG. 8 showing that approximately 30% of the initial ligand shell is replaced. The error for each data point in FIG. 8 was estimated to be roughly ±10% based upon difficulties of measuring the integrals exactly due to line broadening and partial signal overlap. In addition, XPS data of the partially exchanged nanoparticles shows that approximately 28% of the ligand shell consists of thiols. This number was obtained from quantifying the signals for sulfur and phosphorous which gave a thiol:phosphine ratio of 1.0:2.6.

The production of nanoparticles with a mixed phosphine/thiol ligand shell (with a controlled ratio) provides a novel route for the synthesis of fully thiol-stabilized nanoparticles that have two different thiols in the ligand shell. Preliminary experiments have shown that the remaining phosphine-ligands can be exchanged in a subsequent exchange reaction resulting in the formation of thiol-stabilized nanoparticles with a mixed thiol/thiol ligand shell. We are currently investigating if this route produces thiol-stabilized nanoparticles with a controllable ratio of different thiols.

In the case of thiol-for-thiol ligand exchange reactions, mechanistic studies could be used to determine possible reaction pathways of the exchange reactions and to obtain important information about their dynamics. For example, Murray's studies of the dynamics of thiol-for-thiol ligand exchange reactions on 2-3 nm gold nanoparticles could be used to propose an “S_{N}2”-type associative mechanism in which the entering thiol protonates a bound thiolate ligand in the rate-determining step (Hostetler, M. J.; Templeton, A. C.; Murray, R. W. Langmuir 1999, 15, 3782-3789). Evidence that the rate for ligand exchange decreases with increasing length and bulkiness of the incoming thiol ligand further supported this mechanism. These findings were confirmed by Montalti et al. who studied the ligand exchange of pyrene-functionalized nanoparticles with decanethiol using fluorescence spectroscopy. Montalti, M.; Prodi, L.; Zaccheroni, N.; Baxter, R.; Teobaldi, G.; Zerbetto, F. Langmuir 2003, 19, 5172-5174. Recently, the ligand exchange reaction with a stable radical-functionalized disulfide was investigated by EPR (Ionita, P.; Caragheorgheopol, A.; Gilbert, B. C.; Chechik, V. J. Am. Chem. Soc. 2002, 124, 9048-9049). The authors proposed a dissociative mechanism based upon their experimental data in which the rate-determining step is the dissociation of a bound thiolate. The proposed mechanism is probably only valid for nanoparticles initially stabilized with weakly bound ligands such as short-chain alkylthiols, amines, and sulfides.

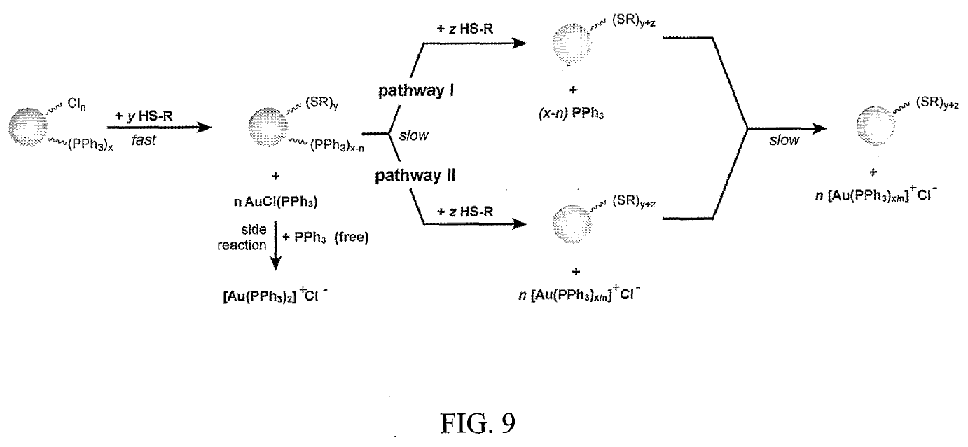

The evidence presented herein, including the NMR product studies and the shapes and chemical shifts of the NMR peaks provide evidence for a three-stage mechanism rather than a pure associative or dissociative mechanism. The proposed mechanism for the ligand exchange reaction of 1.5-nm Auₙ-TPP with thiols is shown in FIG. 9. As mentioned earlier, the different stages most likely overlap but will be treated separately for clarity. The initial stage of the exchange is characterized by the loss of approximately 25% of the phosphine ligands from the nanoparticle in the form of AuCl(PPh₃). This initial phase is very rapid and is probably completed during the first 1-2 minutes of the exchange reaction. The loss of AuCl(PPh₃) supports the absence of chloride ligands in the final nanoparticle and indicates a small decrease in the number of core atoms during ligand exchange. Once no more AuCl(PPh₃) can be produced (in which the chloride ligands in the reactant ligand shell are the limiting substituent), the mechanism for the replacement of the phosphine ligands switches and the remaining phosphines are removed in a second stage as PPh₃.

Replacement of phosphines as PPh₃ can occur via one of two possible pathways: In pathway I (FIG. 9), the remaining PPh₃ ligands first dissociate from the nanoparticle as free PPh₃ and then rapidly react with AuCl(PPh₃) in solution to form [Au(PPh₃)₂]⁺Cl⁻ or higher gold-phosphine salts. Alternatively (FIG. 9, pathway II), PPh₃ is abstracted by direct transfer from the nanoparticle to a closely associated AuCl(PPh₃) in a concerted reaction without ever being free in solution. Both possible pathways result in the same product formation, [Au(PPh₃)₂]⁺Cl⁻ and other multi-phosphine Au(I) complexes. Based upon the trapping experiments (no formation of iminophosphorane until late in the reaction), pathway II appears to be more plausible because PPh₃ is not free in solution at any time during the exchange.

For either pathway I or II, the actual exchange between surface-bound phosphine and thiol could be either associative (with an SN2-type pathway involving incoming thiol helping to displace the thiol), or dissociative (with an S_{N}1-type pathway). Supporting evidence for the feasibility of dissociative exchange includes the decomposition of phosphine-stabilized nanoparticles in the absence of thiol. See, Brown, L. O.; Hutchison, J. E. J. Am. Chem. Soc. 1997, 119, 12384-12385; Benfield, R. E.; Creighton, J. A.; Eadon, D. G.; Schmid, G. Z. Phys. D: At., Mol. Clusters 1989, 12, 533-536. Since the product features an increased number of ligands, the complete mechanism must feature addition steps as well as substitution steps.

During the final period of the ligand exchange (FIG. 9) the ligand shell is being completed and the thiol ligand are reorganized into a more crystalline state with specific associated chemical environments for the ligands. This stage is characterized by a continued downfield shift and broadening of the β-methylene resonances. As mentioned above this rearrangement could be a simple rearrangement of chemisorbed thiolates, or it could also involve loss of hydrogen in a conversion from physisorbed thiol to chemisorbed thiolate.

### EXAMPLES

General Methods: Purified λ-DNA Hind III digest (500 μg/mL) was obtained from New England BioLabs and used as received. According to the specifications provided by the company the double-stranded DNA is digested to completion with Hind III, phenol extracted and dialyzed against 10 mM Tris-HCl (pH 8.0) and 1 mM EDTA. The DNA was stored at −20° C. until just prior to use. All solutions for microscopic analysis were prepared in ultrapure water (resistivity of 18.2 Ω/cm). Chemicals were obtained from Aldrich Chemical Company. Acetonitrile and CH₂Cl₂ were sparged with nitrogen before use. CH₂Cl₂ was dried over calcium hydride prior to use. Silicon monoxide coated 400 mesh copper TEM grids were obtained from Ted Pella and used as received. ¹H/¹³C NMR spectra (300 MHz, CDCl₃ or D₂O) were collected on a Varian Inova 300. UV-visible spectroscopy was performed on a Hewlett-Packard HP 8453 diode array instrument with a fixed slit width of 1 nm using 1-cm quartz cuvettes. Transmission electron microscopy (TEM) was performed on a Philips CM-12 TEM operating at 120 kV. TEM images were recorded and processed as described in Brown, L. O.; Hutchison, J. E. J. Phys. Chem. B 2001, 105, 8911-8916, which is incorporated herein by reference. (2-Mercaptoethyl)-trimethylammonium iodide (1) was prepared according to a procedure described in Warner, M. G.; Hutchison, J. E. Nat. Mater. 2003, 2, 272-277, which is incorporated herein by reference.

Hydrogen tetrachloroaurate (HAuCl₄.3H₂O) was purchased from Strem and was used as received. Dichloromethane was distilled over calcium hydride prior to use. Deuterated chloroform was filtered through a plug of basic alumina prior to use to remove acidic impurities. 1-azido-2,4-dinitrobenzene, 2-(2-mercaptoethoxy)-ethanol, and 2-[2-(2-mercaptoethoxy)ethoxy]ethanol were synthesized according to known procedures (Bailey, A. S.; Case, J. R. Tetrahedron 1958, 3, 113-131; and Woehrle, G. H.; Warner, M. G.; Hutchison, J. E. Langmuir 2004, 20, 5982-5988. All other compounds were purchased from Aldrich Chemical Co. and used as received.

Nuclear magnetic resonance (NMR) spectra were collected at 25° C. on a Varian Unity Inova 300 MHz instrument equipped with a 4-channel probe (¹³C: 75.42 MHz; ³¹P: 121.43 MHz). For ¹H and ¹³C NMR, chemical shifts were referenced to the residual proton resonance of the solvent. For ³¹P NMR spectroscopy, the spectra were referenced to H₃PO₄ (external standard). X-ray photoelectron spectroscopy (XPS) was performed on a Kratos Axis HSi instrument operating at a base pressure of ˜5×10⁻⁹ mm Hg using monochromatic Al Kα radiation at 15 mA and 13.5 kV. Nanoparticle samples were drop-cast from solution onto a clean glass slide. Samples were charge compensated and binding energies were referenced to carbon 1s at 284.4 eV. UV-visible spectra were obtained on a Hewlett-Packard 8453 diode array instrument with a fixed slit width of 1 nm using 1-cm quartz cuvettes. Thermal gravimetric analysis (TGA) was performed on a TA instruments Hi-Res TGA 2950 Thermogravimetric Analyzer under nitrogen atmosphere (flow rate 100 mL/min). Samples (1-2 mg) were deposited onto Al pans either as powders or by drop-casting from dichloromethane and placed in the instrument until a stable weight was obtained prior to analysis. The samples were heated at a rate of 5° C./min up to 100° C., held at that temperature for 15 min to ensure evaporation of all solvent, and then heated up to 500° C. at a rate of 5° C./min.

1-Azido-2,4-dinitrobenzene was synthesized according to literature (Bailey, A. S.; Case, J. R. Tetrahedron 1958, 3, 113-131). ¹H NMR(CDCl₃) δ 7.51 (d, 1H, ³J=8.9 Hz), 8.47 (dd, 1H, ³J=8.9 Hz, ⁴J=2.7 Hz), 8.81 (d, 1H, ⁴J=2.6 Hz). UV-vis (CHCl₃): λₘₐₓ 262, 304 nm.

### Example 1

This example describes the synthesis of [2-(2-mercapto-ethoxy)-ethyl]-trimethylammonium toluene-4-sulfonate (6). First, 2-(2-mercaptoethoxy)-ethanol (2) was synthesized according to the procedure of Latham et al. described in Int. Pub. No. WO 91/14696, which is incorporated herein by reference. Briefly, a solution of 2-(2-chloroethoxy)-ethanol (3.0 g, 24.2 mmol) and thiourea (2.7 g, 35.5 mmol) in 40 mL water was sparged with argon for 30 min and then heated to reflux for 18 h under argon. The mixture was cooled to room temperature and sodium hydroxide (6.0 g, 0.15 mol) in 30 mL deoxygenated H₂O was added. The mixture was refluxed for another 3 h before it was poured onto ice and carefully brought to pH 4 with conc. HCl under argon. The aqueous layer was extracted with 3×20 mL CHCl₃. The combined organic fractions were extracted with 2×20 mL brine, dried over anhydrous sodium sulfate, filtered, and evaporated to dryness under reduced pressure to leave 2.2 g (75%) of the thiol 2 as colorless oil. ¹H NMR (300 MHz, CDCl₃): δ 3.76 (t, 2H, J=4.5), 3.64 (t, 2H, J=6.0), 3.59 (t, 2H, J=4.5), 2.72 (q, 2H, J=6.0), 2.13 (b, 1H), 1.57 (t, 1H, J=8.1). ¹³C NMR (300 MHz, CDCl₃): δ 72.82, 72.16, 61.91, 24.52.

Synthesis of 2-(2-tritylsulfanylethoxy)-ethanol (3): In a 100 mL round bottom flask triphenylmethyl chloride (2.4 g, 8.6 mmol) was dissolved in 30 mL of nitrogen-sparged acetonitrile under gentle heating. To this solution, the thiol 2 (1.0 g, 8.2 mmol) was added and the mixture was stirred at room temperature for 5 h under nitrogen. The solvent was removed and the crude product purified by column chromatography (silica gel; eluent: ethyl acetate) to give 2.0 g (67%) of 3 as colorless solid. TLC (ethyl acetate): R_{f}=0.42. ¹H NMR (300 MHz, CDCl₃): δ 7.46 (d, 6H, J=7.2), 7.33 (m, 9H), 3.68 (t, 2H, J=4.5), 3.43 (t, 2H, J=4.5), 3.33 (t, 2H, J=6.6), 2.47 (t, 2H, J=6.6), 2.01 (b, 1H). ¹³C NMR (300 MHz, CDCl₃): δ 144.92, 129.80, 128.11, 126.90, 71.96, 69.60, 66.88, 61.82, 32.00.

Synthesis of toluene-4-sulfonic acid 2-(2-tritylsulfanylethoxy)-ethyl ester (4): The alcohol 3 (1.9 g, 5.2 mmol) in 10 mL CH₂Cl₂ was slowly added over a 20 minute period to a solution of p-toluenesulfonyl chloride (1.2 g, 6.3 mmol) and pyridine (0.82 g, 10.4 mmol) in 20 mL CH₂Cl₂. The mixture was stirred at room temperature for 2 d and then quenched with 20 mL H₂O. The layers were separated, the aqueous layer was extracted with 3×20 mL diethlyether and the combined organic fractions were washed with 3×20 mL 10% HCl, 2×20 mL H₂O and 2×20 mL brine. The organic fraction was dried over anhydrous sodium sulfate and the solvent removed in vacuo. The crude product was recrystallized from EtOH at −20° C. to yield 1.7 g (63%) of the tosylate 4 as colorless solid. ¹H NMR (300 MHz, CDCl₃): δ 7.77 (d, 2H, J=8.4), 7.40 (d, 6H, J=7.2), 7.30 (m, 11H), 4.07 (t, 2H, J=4.8), 3.46 (t, 2H, J=4.8), 3.18 (t, 2H, J=6.9), 2.41 (s, 3H), 2.35 (t, 2H, J=6.9). ¹³C NMR (300 MHz, CDCl₃): δ 144.87, 144.85, 133.15, 130.00, 129.78, 128.16, 128.10, 126.89, 69.91, 69.27, 68.32, 66.85, 31.75, 21.82.

Synthesis of [2-(2-tritylsulfanylethoxy)-ethyl]-trimethylammonium toluene-4-sulfonate (5): Trimethylamine (80 mg, 1.4 mmol) was added to a solution of the tosylate 4 (680 mg, 1.3 mmol) in 20 mL ethanol and the resulting mixture was brought to reflux for 3 d. After cooling, the solvent was evaporated, the crude product dissolved in 20 mL CH₂Cl₂ and washed with 3×20 mL 10% HCl and 2×20 mL brine. The solvent was removed in vacuo and the residue recrystallized from diethylether/ethanol to yield 500 mg (67%) of 5 as colorless solid. ¹H NMR (300 MHz, CDCl₃): δ 7.75 (d, 2H, J=8.1), 7.40 (d, 6H, J=7.2), 7.30 (m, 9H), 7.16 (d, 2H, J=8.1), 3.92 (b, 2H), 3.74 (b, 2H), 3.44 (s, 9H), 3.27 (t, 2H, J=5.7), 2.41 (t, 2H, J=5.7), 2.32 (s, 3H). ¹³C NMR (300 MHz, CDCl₃): δ 144.85, 144.83, 129.66, 129.64, 128.86, 128.15, 127.00, 125.92, 69.94, 69.97, 65.50, 65.01, 54.65, 31.82, 21.43. MS: m/z 406.2 (M⁺ for C₂₆H₃₂NSO).

Synthesis of [2-(2-mercaptoethoxy)-ethyl]-trimethylammonium toluene-4-sulfonate (6). A 50 mL round bottom flask was sparged with nitrogen for 15 min and then charged with the trityl-protected thiol 5 (500 mg, 0.9 mmol). Deoxygenated trifluoroacetic acid (10 mL) was added to the reaction vessel. The reaction mixture turned orange. After stirring the mixture for 15 min at room temperature, deoxygenated triethylsilane (˜5 mL) was added dropwise until the solution became colorless. The reaction mixture was stirred for another 30 min before the trifluoroacetic acid and triethylsilane were removed in vacuo. The crude reaction mixture was dissolved in 20 mL deoxygenated, deionized water, extracted with 2×20 mL deoxygenated CH₂Cl₂ and evaporated to dryness to yield 250 mg (84%) of the thiol 6 as colorless oil. ¹H NMR (300 MHz, D₂O): δ 7.64 (d, 2H, J=8.1), 7.30 (d, 2H, J=8.1), 3.88 (b, 2H), 3.60 (t, 2H, J=6.0), 3.50 (t, 2H, J=4.5), 3.11 (s, 9H), 2.68 (t, 2H, J=6.0), 2.32 (s, 3H). ¹³C NMR (300 MHz, CDCl₃): δ 140.51, 129.65, 125.59, 118.26, 72.30,65.55, 64.20, 54.12, 23.33, 20.74. MS: m/z 164.1 (M⁺ for C₇H₁₈NSO).

### Example 2

This example describes the synthesis of {2-[2-(2-mercaptoethoxy)-ethoxy]-ethyl}-trimethylammonium toluene-4-sulfonate (11). First, 2-[2-(2-mercaptoethoxy)-ethoxy]-ethanol (7) was prepared using a modification the procedure described by Latham et al. Int. Pub. No. WO 91/14696. Briefly, a solution of 2-[2-(2-chloroethoxy)-ethoxy]-ethanol (2.0 g, 11.9 mmol) and thiourea (1.4 g, 18.4 mmol) in 40 mL water was sparged with argon for 30 min and then heated to reflux for 18 h under argon. The mixture was cooled to room temperature and sodium hydroxide (4.0 g, 0.12 mol) in 20 mL deoxygenated H₂O was added. The mixture was refluxed for another 3 h before it was poured onto ice and carefully brought to pH 4 with conc. HCl under argon. The aqueous layer was extracted with 3×20 mL CHCl₃. The combined organic fractions were extracted with 2×20 mL brine, dried over anhydrous sodium sulfate, filtered, and evaporated to dryness under reduced pressure to leave 1.5 g (76%) of the thiol 7 as colorless oil. The physical data agree with those reported by Lang, H.; Duschl, C.; Vogel, H. Langmuir 1994, 10, 197-210. ¹H NMR (300 MHz, CDCl₃): δ 3.73 (t, 2H, J=4.5), 3.67 (m, 10H), 2.70 (q, 2H, J=6.0), 2.45 (b, 1H), 1.60 (t, 1H, J=6.0). ¹³C NMR (300 MHz, CDCl₃): δ 72.94, 72.61, 70.39, 70.30, 61.78, 24.28.

Synthesis of 2-[2-(2-tritylsulfanyl-ethoxy)ethoxy]-ethanol (8): In a 100 mL round bottom flask triphenylmethyl chloride (3.7 g, 13.3 mmol) was dissolved in 50 mL of nitrogen-sparged acetonitrile under gentle heating. To this solution, the thiol 7 (1.5 g, 9.0 mmol) was added and the mixture was stirred at room temperature for 5 h under nitrogen. The solvent was removed and the crude product purified by column chromatography (silica gel; eluent: ethyl acetate) to give 2.1 g (57%) of 8 as colorless solid. TLC (ethyl acetate): R_{f}=0.42. ¹H NMR (300 MHz, CDCl₃): δ 7.41 (d, 6H, J=7.2 ), 7.33 (m, 9H), 3.71 (t, 2H, J=4.5), 3.59 (t, 2H, J=5.4), 3.58 (t, 2H, J=4.5), 3.44 (t, 2H, J=5.4), 3.31 (t, 2H, J=7.1), 2.44 (t, 2H, J=7.0), 2.00 (b, 1H). ¹³C NMR (300 MHz, CDCl₃): δ 144.97, 129.82, 128.10, 126.87, 72.62, 70.45, 70.36, 69.84, 61.99, 31.77.

Synthesis of toluene-4-sulfonic acid 2-[2-(2-tritylsulfanyl-ethoxy)-ethoxy]-ethyl ester (9): The alcohol 8 (1.5 g, 3.6 mmol) in 10 mL CH₂Cl₂ was slowly added over a 20 minute period to a solution of p-toluenesulfonyl chloride (867 mg, 4.5 mmol) and pyridine (570 mg, 7.2 mmol) in 20 mL CH₂Cl₂. The mixture was stirred at room temperature for 2 d and then quenched with 20 ml H₂O. The layers were separated, the aqueous layer was extracted with 3×20 ml diethlyether and the combined organic fractions were washed with 3×20 mL 10% HCl, 2×20 mL H₂O, and 2×20 mL brine. The organic layer was dried over anhydrous sodium sulfate and the solvent removed in vacuo. The crude product was recrystallized from EtOH at −20° C. to yield 1.2 g (59%) of the tosylate 9 as colorless solid. ¹H NMR (300 MHz, CDCl₃): δ 7.80 (d, 2H, J=8.1), 7.41 (d, 6H, J=7.2), 7.33 (m, 11H), 4.15 (t, 2H, J=5.1), 3.67 (t, 2H, J=4.8), 3.51 (t, 2H, J=5.1), 3.40 (t, 2H, J=4.8), 3.28 (t, 2H, J=6.9), 2.44 (s, 3H), 2.43 (t, 2H, J=6.9). ¹³C NMR (300 MHz, CDCl₃): δ 145.00, 144.96, 133.18, 130.00, 129.80, 128.17, 128.08, 126.86, 70.80, 70.31, 69.84, 69.43, 68.89, 66.82, 31.82, 21.81.

Synthesis of {2-[2-(2-tritylsulfanylethoxy)-ethoxy]-ethyl}-trimethylammonium toluene-4-sulfonate (10): Trimethylamine (95 mg, 1.6 mmol) was added to a solution of the tosylate 9 (900 mg, 1.6 mmol) in 20 mL ethanol and the resulting mixture was brought to reflux for 3 d. After cooling, the solvent was evaporated the crude product dissolved in 20 mL CH₂Cl₂ and washed with 3×20 mL 10% HCl and 2×20 mL brine. The solvent was removed in vacuo and the residue recrystallized from diethylether/ethanol to yield 680 mg (68%) of 10 as colorless solid. ¹H NMR (300 MHz, CDCl₃): δ 7.79 (d, 2H, J=8.1), 7.40 (d, 6H, J=7.2), 7.30 (m, 9H), 7.11 (d, 2H, J=8.1), 3.85 (b, 4H), 3.54 (t, 2H, 4.2), 3.40 (t, 2H, J=4.2), 3.32 (s, 9H), 3.29 (t, 2H, J=6.6), 2.41 (t, 2H, J=6.6), 2.32 (s, 3H). ¹³C NMR (300 MHz, CDCl₃): δ 144.90, 132.64, 131.56, 129.45, 128.78, 128.18, 127.050, 126.01, 70.49, 69.88, 69.80, 66.93, 65.50, 54.80, 32.24, 21.50. MS: m/z 450.4 (M⁺ for C₂₈H₃₆NSO₂).

Synthesis of {2-[2-(2-mercaptoethoxy)-ethoxy]-ethyl}-trimethylammonium toluene-4-sulfonate (11). A 50 mL round bottom flask was purged with nitrogen for 15 min and then charged with the trityl-protected thiol 10 (500 mg, 0.8 mmol). Deoxygenated trifluoroacetic acid (10 mL) was added to the reaction vessel. The reaction mixture turned orange. After stirring the mixture for 15 min at room temperature, deoxygenated triethylsilane (˜5 mL) was added dropwise until the solution becomes colorless. The reaction mixture was stirred for another 30 min before the trifluoroacetic acid and triethylsilane were removed in vacuo. The crude reaction mixture was dissolved in 20 mL deoxygenated, deionized water, extracted with 2×20 mL deoxygenated CH₂Cl₂ and evaporated to dryness to yield 274 mg (90%) of the thiol 2 as colorless oil. ¹H NMR (300 MHz, D₂O): δ 7.56 (d, 2H, J=8.1), 7.24 (d, 2H, J=8.1), 3.84 (b, 2H), 3.56 (s, 4H), 3.54 (t, 2H, J=6.0), 3.45 (t, 2H, J=4.8), 3.05 (s, 9H), 2.60 (t, 2H, J=6.0), 2.27 (s, 3H). ¹³C NMR (300 MHz, CDCl₃): δ 139.50, 129.39, 125.55, 117.81, 72.14, 69.61, 69.15, 65.38, 64.30, 53.94, 23.15, 20.48. MS: m/z 208.2 (M⁺ for C₉H₂₂NSO₂).

### Example 3

This example provides a general procedure for the synthesis of water-soluble Au nanoparticles stabilized by the thiols 1, 6 and 11. The syntheses of the thiol-stabilized gold nanoparticles were carried out according the established ligand-exchange procedure described by Warner, M. G.; Reed, S. M.; Hutchison, J. E. Chem. Mater. 2000, 12, 3316-3320, which is incorporated herein by reference, using the ligands described above. The water-soluble thiol was neutralized using a solid supported base, polyvinylpyridine, prior to use in the ligand exchange reaction to remove remaining trifluoroacetic acid if necessary. Briefly, the starting triphenylphosphine-stabilized nanoparticles (40 mg) (synthesized according the procedure of Weare, W. W.; Reed, S. M.; Warner, M. G.; Hutchison, J. E. J. Am. Chem. Soc. 2000, 122, 12890-12891, which is incorporated herein by reference) were dissolved in 10 mL CH₂Cl₂ and placed in a standard borosilicate test tube. The water-soluble thiol was dissolved in 10 mL deoxygenated, deionized H₂O and added to the test tube. The two-phase reaction mixture was stirred rapidly for 5 h until all of the darkly colored nanoparticles were transferred from the CH₂Cl₂ to the aqueous phase. Once the reaction was complete, the layers were separated, the aqueous layer extracted with 2×10 mL CH₂Cl₂ and the solvent removed under a brisk stream of nitrogen. The crude nanoparticle sample was purified using size exclusion chromatography (Sephadex LH-20) in ultrapure water to remove excess ligand and 5 residual gold salts.

Synthesis of (2-mercaptoethyl)-trimethylammonium iodide-stabilized nanoparticles (Auₙ-TMAT): The synthesis was performed as described in the general procedure using thiol 1 (45 mg, 0.18 mmol) to yield 25 mg Auₙ-TMAT. ¹H NMR (300 MHz, D₂O): δ 3.35 (broad). TEM: d_{CORE}=1.7±0.5 nm.

Synthesis of [2-(2-mercaptoethoxy)-ethyl]-trimethylammonium toluene-4-sulfonate-stabilized Au nanoparticles (Au-MEMA): The synthesis was performed as described in the general procedure using thiol 6 (50 mg, 0.15 mmol) to yield 20 mg Auₙ-MEMA. ¹H NMR (300 MHz, D₂O): δ 7.72, (d), 7.45 (d), 3.19 (broad), 2.49 (s). TEM: d_{CORE}=1.6±0.4 nm.

Synthesis of {2-[2-(2-mercaptoethoxy)-ethoxy]-ethyl}-trimethylammonium toluene-4-sulfonate-stabilized Au nanoparticles (Auₙ-PEGNME). The synthesis was performed as described in the general procedure using thiol 11 (50 mg, 0.13 mmol) to yield 30 mg Auₙ-PEGNME. ¹H NMR (300 MHz, D₂O): δ 7.73, (d), 7.49 (d), 3.61 (broad), 3.20 (broad), 2.51 (s). TEM: d_{CORE}=1.6±0.4 nm.

### Example 4

This example describes formation of nanoassemblies and deposition on SiO-coated TEM grids for analysis. The nanoassemblies were formed by mixing the nanoparticles and the purified fragments of λ-DNA in ultrapure water and incubating at room temperature for 5 minutes. Samples were deposited by aerosoling approximately 10 μL of a premixed sample of λ-DNA and nanoparticles onto silicon monoxide coated 400-mesh copper grids (Ted Pella). Excess water was blotted off the grids with filter paper and the samples were dried under ambient conditions prior to inspection by TEM.

Nanoassemblies of Auₙ-TMAT: In a 1 mL Eppendorff vial filled with 86 μL ultrapure water, 11 μL λ-DNA (c=0.5 μg/μL) were added to 13 μL Auₙ-TMAT (c=3.0 μg/μL).

Nanoassemblies of Auₙ-MEMA: In a 1 mL Eppendorff vial filled with 85 μL ultrapure water, 11 μL λ-DNA (c=0.5 μg/μL) were added to 14 μL Auₙ-MEMA (c=3.0 μg/μL).

Nanoassemblies of Auₙ-PEGNME: In a 1 mL Eppendorff vial filled with 84 μL ultrapure water, 11 μL λ-DNA (c=0.5 μg/μL) were added to 15 μL Auₙ-PEGNME (c=3.0 μg/μL).

### Example 5

This example describes measuring and analyzing the interparticle spacing. TEM images of the assemblies were recorded and processed as described by Brown, L. O.; Hutchison, J. E. J. Phys. Chem. B 2001, 105, 8911-8916, which is incorporated herein by reference, and saved as PICT files. The images were then imported into a program that was written in-house that allows the convenient measurement of interparticle spacing in digitized images. Statistical analysis and creation of histograms were performed using Microsoft's Excel spreadsheet program. The following constraints were used for the analysis in order to eliminate counting of large spacings that are due to incomplete coverage: for Auₙ-TMAT assemblies spacings >3.0 nm were ignored, for Auₙ-MEMA assemblies spacings >3.7 nm were ignored, for Auₙ-PEGNME assemblies spacings >4.4 nm were ignored. These values correspond to the total diameter of a nanoparticle (d_{CORE}=1.6 nm) including the thickness of the ligand shell. Using these constraints approximately 5% of all measurements were discarded.

### Example 6

This example describes molecular modeling of the thiol ligands 1, 6, and 11. Molecular mechanics modeling of the ligands was performed with Spartan SGI Version 5.1.3 using a MM2 force field. The structures were minimized in their fully extended conformation. The lengths l of the ligands were measured from the thiol proton to the outermost proton of the methyl groups to simulate the thickness of the ligand shell. The following lengths were measured: 1 l=7.1 Å, 6 l =10.6 Å, 11 l=14.2 Å.

### Example 7

This example describes the synthesis of triphenylphosphine-stabilized nanoparticles (1.5-nm Auₙ-TPP). Triphenylphosphine-stabilized nanoparticles (1.5-nm Auₙ-TPP) were synthesized using two different procedures. The first procedure was described by Schmid et al. and employs the reduction of AuCl(PPh₃) with diborane gas. Schmid, G. Inorg. Synth. 1990, 27, 214-218. Alternatively, triphenylphosphine-stabilized nanoparticles were synthesized according to a more benign procedure using NaBH4 recently published by our group (See, Weare, W. W.; Reed, S. M.; Warner, M. G.; Hutchison, J. E. J. Am. Chem. Soc. 2000, 122, 12890-12891; Hutchison, J. E.; Foster, E. W.; Warner, M. G.; Reed, S. M.; Weare, W. W.; Buhro, W.; Yu, H. Inorg. Syn. 2004, 34, 228-232). Both materials had identical spectroscopic properties and reactivities in all experiments.

### Example 8

This example describes a general procedure for the preparation of organic-soluble gold nanoparticles. To a solution of 20 mg 1.5-nm Auₙ-TPP in dichloromethane (5 mL) was added 20 mg of the organic-soluble thiol ligand. For thiols with low molecular weight such as propanethiol or mercaptoacetic acid, it is recommended to use only 10-15 mg thiol to 20 mg nanoparticle in order to avoid partial nanoparticle decomposition due to too much excess of thiol. The mixture was stirred rapidly at room temperature until completion of the ligand exchange reaction. The reaction time depends on the incoming ligand and varies from 30 minutes for propanethiol up to 18 hours for long-chain alkylthiols. Upon completion of the exchange reaction the solvent was removed under a stream of nitrogen at room temperature. The crude material was dissolved in the minimum amount of dichloromethane and purified by column chromatography using Sephadex LH-20 to remove byproducts and excess free ligand. The purity of the product (as indicated by the absence of free ligand or molecular gold species) is determined by ¹H NMR spectroscopy, and the material can be further characterized by UV-vis spectroscopy, XPS, TGA, and TEM.

### Example 9

This example describes a general procedure for the preparation of water-soluble gold nanoparticles. To a solution of 20 mg 1.5-nm Auₙ-TPP in dichloromethane (3 mL) was added an aqueous solution of 20 mg of the water-soluble thiol ligand in deionized water (3 mL). For thiols with low molecular weight such as propanethiol or mercaptoacetic acid, it is recommended to use only 10-15 mg thiol to 20 mg nanoparticle in order to avoid partial nanoparticle decomposition due to too much excess of thiol. For ligand exchange reactions using ω-carboxyalkylthiols, the aqueous layer was buffered to pH 8 using a 0.1 mM KH₂PO₄/K₂HPO4 buffer. The biphasic reaction mixture was stirred rapidly at room temperature until completion of the ligand exchange reaction (which can be monitored by the transfer of the darkly colored nanoparticles from the organic to the aqueous phase). The reaction time depends on the incoming ligand and typically varies from 1 h (for short-chain, charged thiols) up to 8 h (for long-chain, neutral thiols). Upon completion of the exchange reaction the layers were separated, and the aqueous layer was washed with dichloromethane (3×5 mL). The aqueous phase was evaporated under a stream of nitrogen at room temperature. The crude material was dissolved in the minimum amount of water and purified by gel filtration chromatography (Sephadex LH-20) to remove residual gold salts and excess free ligand. Alternatively, the crude product can be purified by ultracentrifugation at 340,000×g. The purity of the product (as indicated by the absence of free ligand and molecular gold species) is determined by ¹H NMR spectroscopy, and the material can be further characterized by UV-vis spectroscopy, XPS, TGA, and TEM (vide infra).

### Example 10

This example describes the synthesis of 2,4-Dinitrophenylimino(triphenyl)phosphorane. This compound is the product of trapping PPh₃ with 1-azido-2,4-dinitrobenzene. An authentic sample for characterization purposes was prepared by mixing PPh₃ (12.3 mg, 0.05 mmol) with 1-azido-2,4-dinitrobenzene (9.7 mg, 0.05 mmol) in CHCl₃ (10 mL). After 30 min at room temperature, the solvent was evaporated, and the residue was washed with 20 mL cold CHCl₃. The physical characterization agrees with the literature (Onys'ko, P. P.; Proklina, N. V.; Prokopenko, V. P.; Gololobov, Y. G. Zh. Obshch. Khim. 1984, 54, 325-333).

Combination of ¹H and ¹H{³¹P} NMR (CDCl₃): δ 6.37 (dd, 1H, ³J_{H-H}=9.3 Hz, ⁴J_{H-P}=1.2 Hz), 7.53 (dt, 6H, ³J=7.5 Hz, ⁴J_{H-P}=3.3 Hz), 7.63 (ddt, 3H, ³J_{H-H}=7.2 Hz, ⁴J_{H-H}=2.4 Hz, ⁵J_{H-P}=2.4 Hz), 7.76 (ddd, 6H, ³J_{H-P}=12.6 Hz, ³J_{H-H}=7.2 Hz, ⁴J_{H-H}=2.4 Hz), 7.81 (dd, 1H, J_{H-H}=9.0 Hz, ⁴J_{H-H}=3.0 Hz), 8.63 (dd, 1H, ⁴J_{H-H}=2.7 Hz, ⁵J_{H-P}=3.0 Hz). ³¹P {¹H} NMR (CDCl₃): δ 9.28. UV-vis (CHCl₃): λₘₐₓ 261, 376 nm.

### Example 11

This example describes the synthesis of chlorotriphenylphosphine gold(I), AuCl(PPh)₃. The Au(I) complex was synthesized according to a known procedure (Braunstein, P.; Lehner, H.; Matt, D. Inorg. Synth. 1990, 27, 218-221). The physical characterization is in agreement with the literature (Hussain, M. S.; Hossain, M. L.; Al-Arfaj, A. Transition Met. Chem. 1990, 15, 120-125). UV-visible extinction data (CH₂Cl₂) δ (mol⁻¹ dm³ cm⁻): 2.04×10⁴ (235 nm); 2.57×10³ (268 nm); 1.93×10³ (275 nm). ¹³C NMR (CDCl₃): δ 128.84 (d, ¹J_{C-P}=62.4 Hz), 129.43 (d, ^{2/3}J_{C-P}=12.1 Hz), 134.33 (d, ^{2/3}J_{C-P}=14.1 Hz), 132.19 (d, ⁴J_{C-P}=2.0 Hz). ³¹P{¹H} NMR(CDCl₃): δ 32.97 (s). R_{f}(CH₂Cl₂, silica): 0.82.

### Example 12

This example describes the synthesis of chlorobis(triphenylphosphine)gold, [Au(PPh₃)₂]⁺Cl⁻. This compound was synthesized according to a known procedure (Hussain, M. S.; Hossain, M. L.; Al-Arfaj, A. Transition Met. Chem. 1990, 15, 120-125). The physical data agreed with Hussain et al. ¹H NMR (CDCl₃): δ 7.46 (dt, 6H, ³J_{HH}=7.5 Hz, ⁴J_{HP}=3 Hz), 7.55 (dtt, 3H, ³J_{HH}=7.5 Hz, ⁵J_{HP}=2.7 Hz, ⁴J_{HH}=2.7 Hz), 7.67 (ddd, 6H, ³J_{HP}=12.3 Hz, ³J_{HH}=7.2 Hz, ⁴J_{HH}=2.1 Hz). ³¹P{¹H} NMR (CDCl₃): δ 29.71 (s).

### Example 13

This example describes NMR monitoring of ligand exchange between 1.5-nm Auₙ-TPP and ODT.

General Procedure of Monitoring the Ligand Exchange between 1.5-nm Auₙ-TPP and ODT by NMR. Distilled ODT was placed in an NMR tube and dissolved in CDCl₃. A ¹H NMR spectrum was obtained as a starting point for the reaction. The contents of the NMR tube were then added to a scintillation vial charged with 1.5-nm Auₙ-TPP. The resulting mixture was quickly agitated until everything had dissolved and placed back into the NMR tube. The NMR tube was returned to the instrument, re-shimmed, and spectra were collected at preset time intervals (the first spectrum was typically collected approximately 1 min after mixing).

Monitoring of Ligand Exchange between 1.5-nm Auₙ-TPP and Excess ODT. A solution of ODT (3.0 mg, 10 μmol) in CDCl₃ (0.6 mL) was added to 1.5-nm Auₙ-TPP (5 mg, 20 nmol), and the reaction monitored by ¹H NMR spectroscopy. The first spectrum was recorded at t₀=1 min, followed by a spectrum every 1 min for a total time of 625 min.

Monitoring of Ligand Exchange between 1.5-nm Auₙ-TPP and Stochiometric Amount of ODT to Replace All Nanoparticle-Bound Phosphines. A solution of ODT (3.0 mg, 10 μmol) in CDCl₃ (0.6 mL) was added to 1.5-nm Auₙ-TPP (10 mg, 40 nmol), and the reaction monitored by ¹H NMR spectroscopy. The first spectrum was recorded at t₀=1 min followed by a spectrum every 1 min for a total time of 625 min.

Monitoring of Ligand Exchange between 1.5-nm Auₙ-TPP and ODT in the Presence of Excess PPh₃. A solution of ODT (3.0 mg, 10 μmol) and PPh₃ (10 mg, 40 μmol) in CDCl₃ (0.6 mL) was added to 1.5-nm Auₙ-TPP (10 mg, 40 nmol), and the reaction monitored by ¹H NMR spectroscopy. The first spectrum was recorded at t₀=1 min followed by a spectrum every 1 min for a total time of 625 min.

Trapping Experiment for Free PPh₃ Using 1-Azido-2,4-dinitrobenzene. A solution ODT (10.0 mg, 35 μmol) and 1-azido-2,4-dinitrobenzene (2 mg, 1 μmol) in CDCl₃ (0.6 mL) was added to 1.5-nm Auₙ-TPP (10 mg, 40 nmol), and the reaction monitored by ¹H NMR spectroscopy. The first spectrum was recorded at t₀=1 min followed by a spectrum every 1 min for a total time of 625 min.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A method for preparing a nanoparticle array, comprising:
providing plural phosphine-stabilized nanoparticles;
selecting a desired nanoparticle separation;
identifying a ligand to provide the desired nanoparticle separation;
contacting the phosphine-stabilized nanoparticles with the ligand to form a nanoparticle having a ligand shell;
and
depositing the nanoparticles on a substrate to form the nanoparticle array having the desired nanoparticle separation.

2. The method of claim 1, wherein the ligand shell thickness is from about 0.5 nanometer to about 1.5 nanometer.

3. The method of claim 1, wherein the ligand shell thickness is from about 0.7 nanometer to about 1.4 nanometer.

4. The method of claim 1, wherein the interparticle separation is from about 1.0 nanometers to about 3.0 nanometers.

5. The method of claim 1, wherein the nanoparticle separation is from about 1.5 nanometers to about 2.8 nanometers.

6. The method of claim 1, wherein the substrate comprises a nucleic acid deposited thereon.

7. The method of claim 6, wherein the nucleic acid comprises DNA.

8. The method of claim 7, wherein the DNA comprises double-stranded DNA.

9. The method of claim 1, wherein the nanoparticles comprise gold.

10. The method of claim 1, wherein the nanoparticle has a d_{core} of less than about 2 nanometers.

11. The method of claim 1, wherein the nanoparticle has a d_{core} of less than about 1.5 nanometers.

12. A method for preparing a functionalized nanoparticle, comprising:
providing a phosphine-stabilized nanoparticle;
contacting the phosphine-stabilized nanoparticle with a thiol to produce a ligand exchange mixture; and
purifying the ligand exchange mixture by chromatography to provide the functionalized nanoparticle.

13. The method of claim 1, wherein chromatography comprises gel filtration chromatography.

14. The method of claim 11, further comprising ultracentrifugation.

15. The method of claim 14, wherein ultracentrifugation comprises ultracentrifugation of the ligand exchange mixture.

16. The method of claim 12, wherein the functionalized nanoparticle has a d_{core} substantially the same as that of the phosphine-stabilized nanoparticle.

17. The method of claim 12, wherein the functionalized nanoparticle comprises gold.

18. The method of claim 12, wherein the functionalized nanoparticle has a d_{core} of less than about 2 nanometers.

19. The method of claim 12, wherein the functionalized nanoparticle has a d_{core} of less than about 1.5 nanometers.

20. The method of claim 12, wherein plural substantially monodisperse functionalized nanoparticles are produced.

21. The method of claim 20, wherein the plural nanoparticles have a d_{core} of about 1.5 nanometers.
